(19) United States
(12) Patent Application Publication
(10) Pub. No.: US 2024/0284530 A1
(43) Pub. Date: Aug. 22, 2024

(54) SYSTEMS AND METHODS FOR N-LINK MULTI-LINK OPERATION

(71) Applicant: QUALCOMM Incorporated, San Diego, CA (US)

(72) Inventors: Gyanranjan Hazarika, Milpitas, CA (US); Abhishek Pramod Patil, San Diego, CA (US); Sandip HomChaudhuri, San Jose, CA (US); Krishnakumar Muthusamy, Danville, CA (US); Uraj Singh Sasan, Bangalore (IN); Gaurang Naik, San Diego, CA (US)

(21) Appl. No.: 18/170,836

(22) Filed: Feb. 17, 2023

(51) Int. Cl. H04W 76/15; H04L 5/00; H04W 72/0446

(52) U.S. Cl. CPC H04W 76/15; H04L 5/0048; H04W 72/0446

(57) ABSTRACT

This disclosure provides methods, components, devices and systems for communicating information of multiple wireless access points (APs) affiliated with an AP multi-link device (MLD). Some aspects more specifically relate to techniques for communicating information regarding multiple APs affiliated with an AP MLD in multiple response frames. In some examples, a first response frame may include information regarding a first set of APs that is less than all of the APs indicated by a wireless station (STA) MLD request and a second response frame may include information regarding a second set of APs including one or more AP of the APs missing from the first set of APs. Some examples may additionally or alternatively provide for an AP MLD signaling an indication of a number of allowed association links with respect to the AP MLD, such as for establish a maximum number of allowed association links.

### TECHNICAL FIELD

This disclosure relates generally to wireless communication, and more specifically, to communicating information of multiple wireless access points (APs) affiliated with an AP multi-link device (MLD).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, the wireless network communication protocols implemented, such as those promulgated by the Wi-Fi Alliance (WFA), may establish various size and other parameters with respect to data communication elements. For example, 802.11 standards provide a maximum data unit size for a non-high throughput (HT) management MPDU (MMPDU) as 2304 bytes. Moreover, a WFA constraint in 6G band for a management frame size is 1840 octets based upon a maximum known interoperability testing (IOP) limit. Communication of various information, such as that of signaling with respect to multi-link operation (MLO), may be confined by one or more frame size constraint.

### SUMMARY

The systems, methods and devices of this disclosure each have several innovative aspects, no single one of which is solely responsible for the desirable attributes disclosed herein.

One innovative aspect of the subject matter described in this disclosure may be implemented in a wireless communication device. The wireless communication device of some examples includes at least one memory and at least one processor communicatively coupled with the at least one memory. The at least one processor of some examples is operable to cause the wireless communication device to transmit a first request regarding a plurality of access points (APs) affiliated with a first AP multi-link device (MLD). The at least one processor of some examples is further operable to cause the wireless communication device to receive a first response frame including first information regarding a first set of APs of the plurality of APs affiliated with the first AP MLD, the first set of APs being less than all APs of the plurality of APs that are requested. The at least one processor of some examples is also operable to cause the wireless communication device to receive a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

Another innovative aspect of the subject matter described in this disclosure may be implemented in a method for wireless communication. The method of some examples includes transmitting a first request regarding a plurality of APs affiliated with a first AP MLD. The method of some examples further includes receiving a first response frame including first information regarding a first set of APs of the plurality of APs affiliated with the first AP MLD, the first set of APs being less than all APs of the plurality of APs that are requested. The method of some examples also includes receiving a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

In some examples, the methods and wireless communication devices may, responsive to the first information missing information of one or more APs of the plurality of APs that are requested, transmit a second request for additional information missing from the first information about APs of the plurality of APs that are requested.

In some examples, the methods and wireless communication devices may receive the first response frame and the second response frame in association with the first request without transmission of a second request regarding the at least one AP.

In some examples, the methods and wireless communication devices may receive an indication of a number of allowed association links with respect to the first AP MLD, a number of APs of the plurality of APs the first request is regarding being less than or equal to the number of allowed association links.

Another innovative aspect of the subject matter described in this disclosure may be implemented in a wireless communication device. The wireless communication device of some examples at least one memory and at least one processor communicatively coupled with the at least one memory. The at least one processor of some examples is operable to cause the wireless communication device to receive a first request regarding a plurality of APs affiliated with a first AP MLD. The at least one processor of some examples is further operable to cause the wireless communication device to transmit a first response frame including first information regarding a first set of APs selected from the plurality of APs affiliated with the first AP MLD, the first set of APs being less than all APs of the plurality of APs that are requested. The at least one processor of some examples is also operable to cause the wireless communication device to transmit a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

Another innovative aspect of the subject matter described in this disclosure may be implemented in a method for wireless communication. The method of some examples includes receiving a first request regarding a plurality of APs affiliated with a first AP MLD. The method of some examples further includes transmitting a first response frame including first information regarding a first set of APs selected from the plurality of APs affiliated with the first AP MLD, the first set of APs being less than all APs of the plurality of APs that are requested. The method of some examples also includes transmitting a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

In some examples, the methods and wireless communication devices may include in the first response frame one or more indicators for indicating that the first information is missing information of the one or more APs of the plurality of APs that are requested, the second request being received in association with the one or more indicators indicating that the first information is missing information of the one or more APs.

In some examples, the methods and wireless communication devices may include in the first response frame one or more indicators for indicating that the first information is missing information of the one or more APs of the plurality of APs that are requested, the second request being received in association with the one or more indicators indicating that the first information is missing information of the one or more APs.

In some examples of the methods and wireless communication devices, the first request may be a first multi-link (ML) probe request for information regarding the plurality of APs affiliated with the first AP MLD, the first response frame being a first ML-probe response frame, and the second response frame being a second ML-probe response. The methods and wireless communication devices may omit, from the first ML-probe response frame, multiple basic service set identification (MBSSID) elements for the first set of APs when the plurality of APs affiliated with the first AP MLD associated with the first request for information include a first AP of the wireless communication device transmitting the first ML-probe response frame, the first AP associated with a transmitted basic service set identification (BSSID) in a MBSSID. Additionally or alternatively, the methods and wireless communication devices may omit, from the first ML-probe response frame, MBSSID elements for the first set of APs except for one or more MBSSID elements for a second AP, the second AP being an AP affiliated with the first AP MLD other than the first AP of the wireless communication device transmitting the first ML-probe response frame, when the plurality of APs affiliated with the first AP MLD associated with the first request for information do not include an AP transmitting the first ML-probe response frame, the first AP associated with a BSSID in a MBSSID. Additionally or alternatively, the methods and wireless communication devices may omit, from the first ML-probe response frame, out of band (OOB) information with respect to frequency bands outside of a frequency band through which the first ML-probe response frame and the second ML-probe response frame are receive.

Another innovative aspect of the subject matter described in this disclosure may be implemented in a wireless communication device. The wireless communication device of some examples at least one memory and at least one processor communicatively coupled with the at least one memory. The at least one processor of some examples is operable to cause the wireless communication device to receive an indication of a number of APs affiliated with a first AP MLD. The at least one processor of some examples is further operable to cause the wireless communication device to receive an indication of a number of allowed association links with respect to the first AP MLD. The at least one processor of some examples is also operable to cause the wireless communication device to transmit a first request regarding a plurality of APs affiliated with the first AP MLD. The at least one processor of some examples is further operable to cause the wireless communication device to receive a first response frame including first information regarding a first set of APs of the plurality of APs, a number of APs of the first set of APs being less than or equal to the number of allowed association links.

Another innovative aspect of the subject matter described in this disclosure may be implemented in a method for wireless communication. The method of some examples includes receiving an indication of a number of APs affiliated with a first AP MLD. The method of some examples further includes receiving an indication of a number of allowed association links with respect to the first AP MLD. The method of some examples also includes transmitting a first request regarding a plurality of APs affiliated with the first AP MLD. The method of some examples further includes receiving a first response frame including first information regarding a first set of APs of the plurality of APs, a number of APs of the first set of APs being less than or equal to the number of allowed association links.

In some examples of the methods and wireless communication devices, the number of APs of the first set of APs is less than the number of allowed association links. The methods and wireless communication devices of some examples analyze the first information for carrying information of less than all APs of the plurality of APs that are requested. The methods and wireless communication devices of some examples further transmit, in association with the first information carrying information of less than all APs of the plurality of APs that are requested, a second request.

Another innovative aspect of the subject matter described in this disclosure may be implemented in a wireless communication device. The wireless communication device of some examples at least one memory and at least one processor communicatively coupled with the at least one memory. The at least one processor of some examples is operable to cause the wireless communication device to transmit an indication of a number of APs affiliated with a first AP MLD. The at least one processor of some examples is further operable to cause the wireless communication device to transmit an indication of a number of allowed association links with respect to the first AP MLD. The at least one processor of some examples is also operable to cause the wireless communication device to receive a first request regarding a plurality of APs affiliated with the first AP MLD. The at least one processor of some examples is further operable to cause the wireless communication device to transmit a first response frame including first information regarding a first set of APs of the plurality of APs, a number of APs of the first set of APs being less than or equal to the number of allowed association links.

Another innovative aspect of the subject matter described in this disclosure may be implemented in a method for wireless communication. The method of some examples includes transmitting an indication of a number of APs affiliated with a first AP MLD. The method of some examples further includes transmitting an indication of a number of allowed association links with respect to the first AP MLD. The method of some examples also includes receiving a first request regarding a plurality of APs affiliated with the first AP MLD. The method of some examples further includes transmitting a first response frame including first information regarding a first set of APs of the plurality of APs, a number of APs of the first set of APs being less than or equal to the number of allowed association links.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point and one or more wireless stations.

FIG. 3 shows an example N-link access point (AP) multi-link device (MLD) where a multi-link (ML)-probe response frame is communicated via the 5G low (5GL) link of the AP MLD according to some aspects of the present disclosure.

FIG. 4 shows an example of m N-link AP MLDs where a ML-probe response frame is communicated via the 6G high (6GH) link of the second AP MLD according to some aspects of the present disclosure.

FIG. 5 shows a specific example of 4 5-link AP MLDs in which a ML-probe response frame is communicated via the 6GH link of the second AP MLD according to some aspects of the present disclosure.

FIG. 6 shows a ladder diagram of multi-link operation (MLO) of an example in which a STA MLD making a ML-probe request regarding multiple APs determines remaining information missing from a corresponding ML-probe response frame for obtaining multiple ML-probe response frames according to some aspects of the present disclosure.

FIG. 7 shows a ladder diagram of MLO of another example in which a STA MLD making a ML-probe request regarding multiple APs determines remaining information missing from a corresponding ML-probe response frame for obtaining multiple ML-probe response frames according to some aspects of the present disclosure.

FIG. 8 shows a ladder diagram of MLO of an example in which an AP MLD providing a subsequent ML-probe response frame regarding multiple APs determines remaining information missing from an initial ML-probe response frame for providing multiple ML-probe response frames according to some aspects of the present disclosure.

FIG. 9 shows a ladder diagram of MLO of an example in which an AP MLD provides multiple ML-(re)association response frames according to some aspects of the present disclosure.

FIG. 10 shows a communication link diagram illustrating an example in which a N-link MLD may select a communication link for a N-link request and response session according to some aspects of the present disclosure.

FIG. 11 shows a flowchart illustrating an example process 1100 performable at a wireless AP that supports transmitting multiple response frames of a N-link request and response session according to some aspects of the present disclosure.

FIG. 12 shows a flowchart illustrating an example process 1200 performable at a wireless STA MLD that supports receiving multiple response frames of a N-link request and response session according to some aspects of the present disclosure.

FIG. 13 shows a flowchart illustrating an example process 1300 performable at a wireless AP that supports transmitting response frames in accordance with a number of allowed association links parameter according to some aspects of the present disclosure.

FIG. 14 shows a flowchart illustrating an example process 1400 performable at a wireless STA MLD that supports receiving response frames in accordance with a number of allowed association links parameter according to some aspects of the present disclosure.

FIG. 15 shows a block diagram of an example wireless communication device that supports transmitting multiple response frames of a N-link request and response session according to some aspects of the present disclosure, as well as that supports transmitting response frames in accordance with a number of allowed association links parameter according to some aspects of the present disclosure.

FIG. 16 shows a block diagram of an example wireless communication device that supports receiving multiple response frames of a N-link request and response session according to some aspects of the present disclosure, as well as that supports receiving response frames transmitted in accordance with a number of allowed association links parameter according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein may be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to multi-link (ML) wireless communication and more particularly to communicating information of multiple wireless access points (APs) affiliated with an AP multi-link device (MLD). Some aspects more specifically relate to techniques for communicating information regarding multiple APs affiliated with an AP MLD in multiple response frames. In some examples, a first response frame may include information regarding a first set of APs that is less than all of the APs indicated by a wireless station (STA) MLD request and a second response frame may include information regarding a second set of APs including one or more AP of the APs missing from the first set of APs. For example, an AP MLD may determine that communicating information in association with a request (such as a ML-probe request, a ML-association request, a ML-reassociation request, etc.) from a STA MLD regarding multiple APs affiliated with an AP MLD would result in a size of response frame (such as a ML-probe response frame, a ML-association response frame, a ML-reassociation response frame, etc.) being exceeded, and correspondingly multiple response frames may be transmitted for different sets of APs of the APs that are requested. Some examples may additionally or alternatively provide for an AP MLD signaling an indication of a number of allowed association links (such as via a number of allowed association field) with respect to the AP MLD, such as for establish a maximum number of allowed association links. An AP MLD may select a number of APs of the APs that are requested for including information in the first response frame based at least in part on a number of allowed association links parameter, and correspondingly multiple response frames may be transmitted for different sets of APs of the APs that are requested. In some examples, a subsequent request may be for additional information missing from a response frame APs of the APs that were requested in a previous request. Multiple response frames may be transmitted for different sets of APs of the APs that are requested without a subsequent request regarding information for one or more APs of the APs missing in a previous response, in accordance with some examples.

Particular aspects of the subject matter described in this disclosure may be implemented to realize one or more of the following potential advantages. Communicating information regarding multiple APs affiliated with an AP MLD in multiple response frames facilitates implementing N-link (such as 1≤N≤15) multi-link operation (MLO) with respect to AP MLDs and STA MLDs in a wireless network, such as for realizing latency and throughput gain. Multiple response frames implemented in accordance with concepts of the present disclosure address the impact of N-link implementations on a response frame, accommodating size constraints (such as a maximum data unit size) as may be imposed by communication protocols. MLO having greater flexibility with respect to the number and types of links between AP MLDs and STA MLDs may be implemented in association with communicating information regarding multiple APs affiliated with an AP MLD in multiple response frames. Implementing a number of allowed association links parameter with respect to the AP MLD according to concepts of the present disclosure may also lessen the impact of N-link implementations on a response frame. A number of allowed association links parameter may be implemented in combination with communicating information regarding multiple APs affiliated with an AP MLD in multiple response frames for facilitating latency and throughput gain.

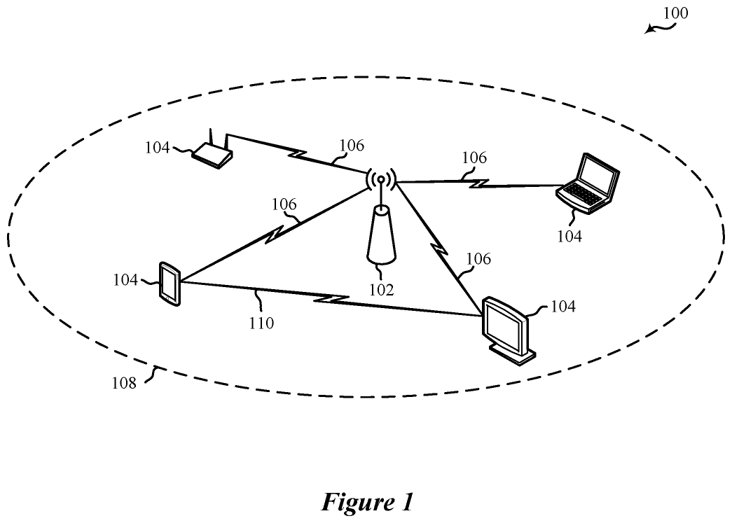

FIG. 1 shows a block diagram of an example wireless communication network 100. According to some aspects, the wireless communication network 100 may be an example of a wireless local area network (WLAN) such as a Wi-Fi network (and will hereinafter be referred to as WLAN 100). For example, the WLAN 100 may be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also may include multiple APs 102. AP 102 shown in FIG. 1 may represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) may be further improved by a small cell which is supported by an AP serving as a miniature base station. Furthermore, private cellular networks also may be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons may include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 may be covered by more than one AP 102 and may associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also may communicate over other frequency bands such as shared licensed frequency bands, where multiple operators may have a license to operate in the same or overlapping frequency band or bands.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

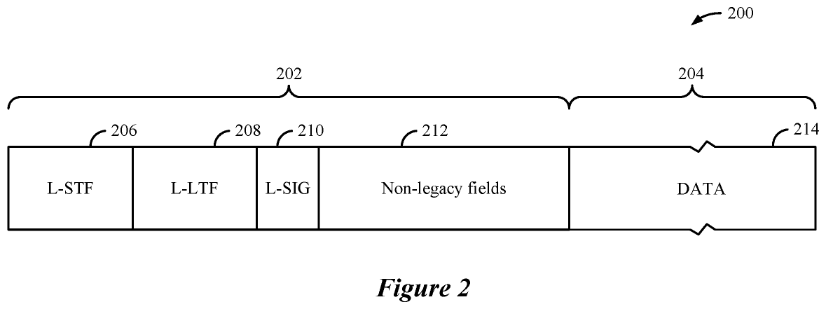

FIG. 2 shows an example protocol data unit (PDU) 200 usable for wireless communication between a wireless AP 102 and one or more wireless STAs 104. For example, the PDU 200 may be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

To support MLO techniques, an AP MLD and a STA MLD may exchange supported MIO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

MLO according to examples of the present disclosure supports N-link operation. N-link operation may, for example, provide support for a wide range (such as 1≤N≤15) of communication links between the STA MLD and the AP MLD, or may otherwise provide support for a relatively large number (such as N≥4) of links between the STA MLD and the AP MLD. N-link support, however, impacts aspects of the exchange of various information between the STA MLD and AP MLD. For example, the exchange of supported MLO capability information via ML-probe requests and ML-probe response frames for establishing multiple different communication links may be burdened with information with respect to a large number of APs affiliated with the AP MLD. Although perhaps not impacted to the extent of a ML-probe request and ML-probe response, the exchange of MLO information via ML-association and reassociation (referred to collectively as (re)association) requests and ML-(re)association response frames may be likewise burdened with information with respect to a large number of APs affiliated with the AP MLD.

To illustrate, a ML-probe response frame as provided by a responding AP MLD for N-link MLO may include (N−1) profile reporting in a basic multi-link element (BMLE) of the response frame and (N−1) AP inclusion in the reduced neighborhood report (RNR) element. It can be seen that information for the ML-probe response is impacted by the number, N, of the links in N-link MLO.

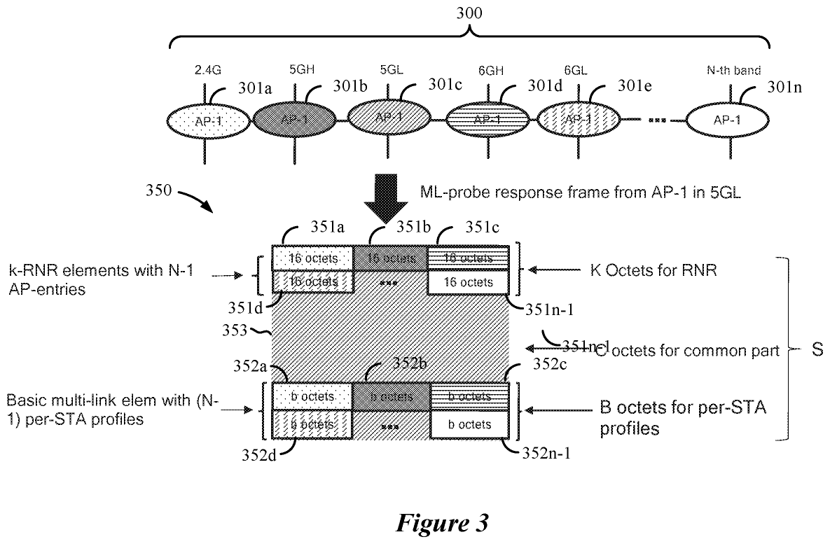

FIG. 3 shows an example N-link AP MLD where a ML-probe response frame is communicated via the 5GL link of the AP MLD according to some aspects of the present disclosure. The AP MLD 300 in the example of FIG. 3 provides a N-link MLD with two 6G links. In particular, AP MLD 300 includes an AP 301a configured for communication in 2.4G bands, an AP 301b configured for communication in 5G high (5GH) bands, an AP 301c configured for communication in 5G low (5GL) bands, an AP 301d configured for communication in 6G high (6GH) bands, and AP 301e configured for communication in 6G low (6GL) bands, and an AP 301n configured for communication in N^{th} bands.

The ML-probe response frame 350 (such as may correspond to PDU 200 of FIG. 2), communicated by the AP 301c of the AP MLD via the 5GL link in the example of FIG. 3 includes RNR elements each containing entries for N−1 AP neighbors, a basic multi-link element containing per-STA profiles for N−1 AP neighbors, and a common part. The octets of the common part element (C octets, shown as common part elements 353 in the example) provide AP MLD level information common to all STA MLDs. The common part is the portion of the frame body which carries fields and elements applicable to the transmitting AP. If the value of a field or an element carried on the common part is also applicable to the reported AP (whose profile is carried in the per-STA profile), then those fields/elements are inherited by the reported AP's profile and the per-STA profile will not include the corresponding field or element. The octets of the RNR elements and the octets of the basic multi-link element vary in number and content based on the number of links (such as the corresponding to the APs affiliated with the AP MLD of the transmitting AP) for MLO. The RNR elements include AP entries providing information regarding neighbor APs across k-RNR elements in the ML-probe response frame. Accordingly, the ML-probe response frame 350 includes K octets for RNR having k-RNR elements with N−1 AP entries (shown as the AP entries 351a, 351b, 351c, 351d, and 351n-1 corresponding to the APs 301a, 301b, 301d, 301e, and 301n, respectively), where K=((k−1)*255+x), k is an integer value, such as in the range of 2 to 5, and x is the number of octets in the kth RNR element. The basic multi-link element includes per-STA profile entries providing information regarding each corresponding STA operating in one link. Accordingly, the ML-probe response frame 350 includes B octets for per-STA profiles having N−1 per-STA profile entries (shown as the per-STA profile entries 352a, 352b, 352c, 352d, and 352n-1 corresponding to the APs 301a, 301b, 301d, 301e, and 301n, respectively), where B=((N−1)*b) and b is the average size of the per-STA profiles in the basic multi-link element in the ML-probe response frame.

From the above, the ML-probe response frame size for N-link MLO in the AP MLD example of FIG. 3 may be give as:

$$S = K + C + B octets . \qquad ( 1 )$$

### Or as:

$$S = ( ( k - 1 ) * 255 + x ) + C + ( ( N - 1 ) * b ) ocetets . \qquad ( 2 )$$

It can be seen from equation 2 above that the size of the ML-probe response frame is impacted by the number of links implemented in MLO. This impact is increased as the number of links increases in N-link MLO implementations.

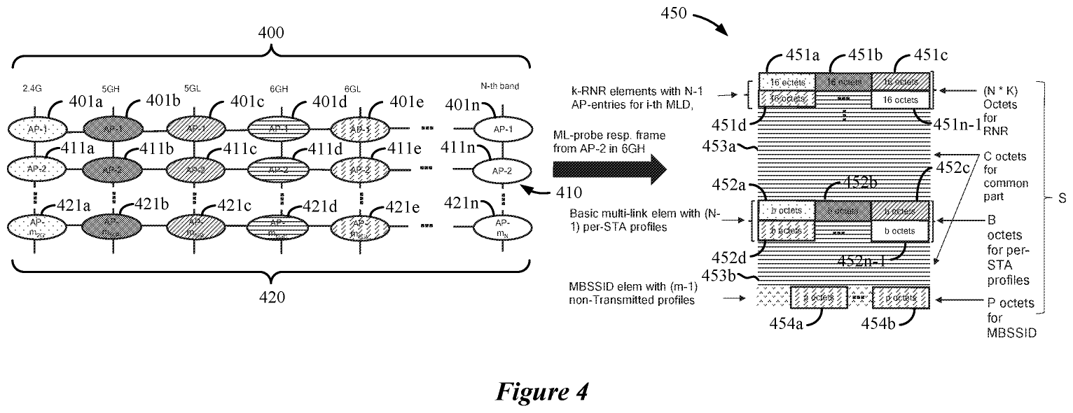

The impact on ML-probe response frame size is further increased by N-link MLO implementations having multiple basic service sets, such as in 6G MLO. FIG. 4 shows an example of m N-link AP MLDs where a ML-probe response frame is communicated via the 6GH link of the second AP MLD according to some aspects of the present disclosure. The AP MLDs 400, 410, and 420 in the example of FIG. 4 each provide a N-link MLD with two 6G links. In particular, AP MLD 400 includes an AP 401a configured for communication in 2.4G bands, an AP 401b configured for communication in 5GH bands, an AP 401c configured for communication in 5GL bands, an AP 401d configured for communication in 6GH bands, and AP 401e configured for communication in 6GL bands, and an AP 401n configured for communication in N^{th} bands. AP MLD 410 includes an AP 411a configured for communication in 2.4G bands, an AP 411b configured for communication in 5GH bands, an AP 411c configured for communication in 5GL bands, an AP 411d configured for communication in 6GH bands, and AP 411e configured for communication in 6GL bands, and an AP 411n configured for communication in N^{th} bands. AP MLD 420 includes an AP 421a configured for communication in 2.4G bands, an AP 421b configured for communication in 5GH bands, an AP 421c configured for communication in 5GL bands, an AP 421d configured for communication in 6GH bands, and AP 421e configured for communication in 6GL bands, and an AP 421n configured for communication in N^{th} bands. According to some examples, the m APs in the 6GH link may be in a multiple BSSID (MBSSID) and the AP 411d of the AP MLD 410 may the transmitted AP of that set.

The ML-probe response frame 450 (such as may correspond to PDU 200 of FIG. 2), communicated by the AP 411d of the AP MLD 410 via the 6GH link in the example of FIG. 4 includes RNR elements each containing entries for N−1 AP neighbors, a basic multi-link element containing per-STA profiles for N−1 AP neighbors, a MBSSID element containing AP profiles for m−1 non-transmitted APs, and a common part. The octets of the common part element (C octets, shown as common part elements 453a and 453b in the example) provide AP MLD level information common to all STAs, and may be as described above. The octets of the RNR elements, the octets of the basic multi-link element, and the octets of the MBSSID element vary in number and content based on the number of links (such as corresponding to the AP MLDs of the non-transmitting APs and corresponding to the APs affiliated with the AP MLD of the transmitting AP) for MLO. The RNR elements include AP entries providing information regarding neighbor APs for the i^{th} AP MLD across k-RNR elements in the ML-probe response frame. Accordingly, the ML-probe response frame 450 includes K octets for RNR having k-RNR elements with N−1 AP entries (shown as the AP-entries 451a, 451b, 451c, 451d, and 451n-1 corresponding to the APs 411a, 411b, 411d, 411c, and 411n, respectively) for the i^{th} (i−1 to (m*K)) AP MLD, where K=((k−1)*255+x), and thus N*K octets are included for RNR. The basic multi-link element includes per-STA profiles provide entries providing information regarding each corresponding STA operating in one link. Accordingly, the ML-probe response frame 450 includes B octets for per-STA profiles having N−1 per-STA entries (shown as the per-STA entries 452a, 452b, 452c, 452d, and 452n-1 corresponding to the APs 411a, 411b, 411d, 411e, and 411n, respectively), where B=((N−1)*b). The MBSSID element includes AP profile entries providing information for m−1 non-transmitted APs in the 6GH link MBSSID set. Accordingly, the ML-probe response frame 450 includes MBSSID elements with (m−1) non-transmitted AP profiles occupying a total of P octets.

From the above, the ML-probe response frame size for N-link MLO in the m AP MLD example of FIG. 4 may be give as:

$$S = ( N * K ) + C + B + P octets . \qquad ( 3 )$$

### Or as:

$$S = N * ( ( k - 1 ) * 255 + x ) + C + ( ( N - 1 ) * b ) + ( ( m - 1 ) * ( ( m - 1 ) * p ) ) octets . \qquad ( 4 )$$

The increased impact of MBSSID on the size of a ML-probe response frame may be seen by comparing equations 3 and 4 of the m AP MLD example with equations 1 and 2 of the AP MLD example above.

It should be understood that the number and configuration of APs shown with respect to the AP MLD 300 in FIG. 3 and the AP MLDs 400, 410, and 420 in FIG. 4 are illustrative of numbers and configurations of APs that may be implemented with respect to N-link MLO. Similarly, the number and configuration of AP MLDs shown in FIG. 4 is illustrative of the numbers and configurations of AP MLDs that may be implemented with respect to N-link MLO. The concepts of the present disclosure are not limited to application with respect to the numbers or configurations of APs shown. AP MLDs implementing N-link MLO according to concepts herein may, for example, may implement a number of APs in the range of 1 to 15. Some examples of an AP MLD implementing N-link MLO according to concepts herein may implement greater than 15 APs.

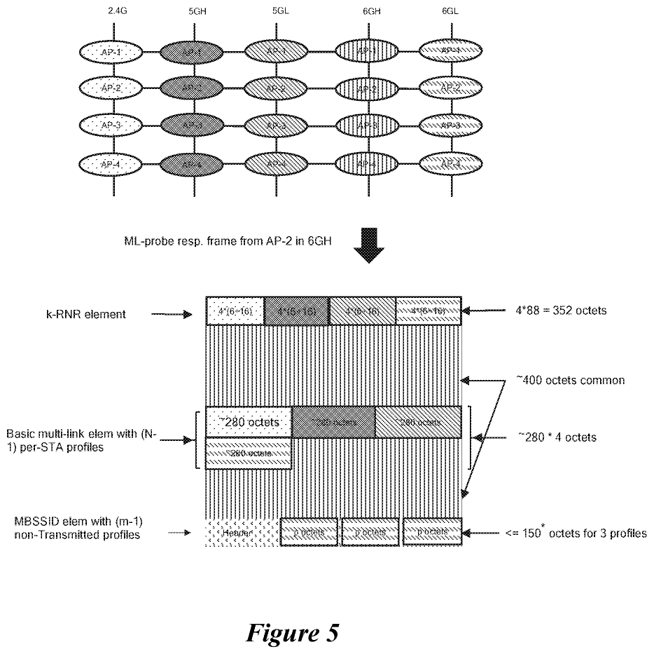

FIG. 5 shows a specific example of 4 5-link AP MLDs in which a ML-probe response frame is communicated via the 6GH link of the second AP MLD according to some aspects of the present disclosure. In the example of FIG. 5, each AP MLD has 5 affiliated APs for providing the respective 5 links The transmitting AP in the 6GH link responds to a ML-probe request for the complete profiles (in this example, 5−1=4 profiles) of the AP MLD of which the transmitting AP is part of. The ML-probe response frame is expected to carry the 4 ML-partners in the AP MLD of the transmitting AP in its RNR elements, as well as the carrying the neighbor APs corresponding to the AP MLDs of the 3 non-transmitting APs in its RNR elements. That is, the ML-probe response frame in the example of FIG. 5 is expected include 4 neighbor APs pertaining to each of the 4 AP MLDs in the RNR elements, resulting in a total of 16 neighbor APs across the k-RNR elements in the ML-probe response frame. The ML-probe response frame of this example also includes a MBSSID element carrying the profiles for the three non-transmitting 6GH link APs.

Wireless network communication protocols, such as those promulgated by the Wi-Fi Alliance (WFA), may establish various size and other parameters with respect to data communication elements. For example, 802.11 standards provide a maximum data unit size for a non-high throughput (HT) management MPDU (MMPDU) as 2304 bytes. However, a WFA constraint in 6G band for a management frame size is 1840 octets based upon a maximum known interoperability testing (IOP) limit. Although being a 6G management frame size parameter, similar system constraints may be extrapolated to 2G and 5G as well. Accordingly, implementations of N-link MLD scalability may be confined within the range of ML-probe response frame size of 1840 octets or less (S≤1840 octets).

Referring again to the ML-probe response frame of the specific example of FIG. 5, the RNR element includes 4*88=352 octets, the basic multi-link element includes approximately 4*280-1120 octets, the MBSSID element includes 150 octets (each non-transmitting AP profile is of length at least 50 octets, where 25 octets are the mandatory three elements per spec per non-transmitting AP profile and 25 octets carry the basic ML element corresponding to the AP MLD that non-transmitting AP is part of), and the common part includes approximately 400 octets. Accordingly, the ML-probe response frame size for 5-link MLO in the 4 AP MLD example of FIG. 5 may be calculated as:

$$S = 352 + \sim 400 + ( 4 * ( \sim 280 ) ) + 150 octets . \qquad ( 5 )$$

From the above, it can be seen that the size of the ML-probe response frame (S≥2200) in the 4 5-link AP MLDs example would exceed the 6G WFA frame size constraint (2200>1840).

Although the above examples have been given with reference to ML-probe requests and ML-probe response frames, it is to be understood that concepts of the present disclosure are applicable with respect to additional and alternative aspects of wireless communication between MLDs. For example, similar size constraints may be applicable with respect to ML-(re)association response frames communicating information of a plurality of APs affiliated with an AP MLD in response to a ML-(re)association request. Although a ML-(re)association response frame does not carry RNR elements and MBSSID elements, the inclusion of complete profiles of N−1 links carried in the basic multi-link element impacts the size of the ML-(re)association response frame.

A size, as it applies to the size constraints discussed above, may correspond to a duration (such as in terms of time, for example a number of milliseconds). Additionally or alternatively, a size of the size constraints may correspond to a length (such as in terms of a number of bytes). Where size constraints based on both duration and time are applicable to a particular aspect of wireless communication between MLDs, the PPDU limit may be the smaller of the applicable duration or time constraint.

MLO operation in accordance with some aspects implements techniques for communicating information regarding multiple APs affiliated with an AP MLD in multiple response frames. A STA MLD or other non-AP MLD may request information regarding all or a partial list of APs that are part of an AP MLD. In some examples, the STA MLD may request complete profiles of all the requested APs in a ML-probe request frame does not include a request element in the frame and a probe request multi-link element in the ML-probe request frame does not include any per-STA profile. Alternatively, the STA MLD may request profiles of a subset of the requested APs by including per-STA profile information for each AP and additionally specifying the complete or partialness of the requested profile by controlling a complete profile requested subfield of a STA control field in the per-STA profile. Non-AP MLDs may, for example, employ either of the above options pre or post connection if it desires complete profiles of the affiliated APs of a target AP MLD. A ML-probe response frame provided in response to either of the techniques for requesting information regarding all or a partial list of APs that are part of an AP MLD may, if not otherwise implemented in accordance with aspects of the present disclosure, exceed one or more frame size constraints. Accordingly, in some examples, a first ML-probe response frame may include information regarding a first set of APs that is less than all the APs indicated by a ML-probe request, a second ML-probe response frame may include information regarding a second set of APs including one or more APs missing from the first set of APs, and so on.

In some examples, STA MLDs or other non-AP MLDs are enabled to follow up with a subsequent ML-probe request when an AP MLD does not include all the requested APs in the ML-probe response frame. For example, a first ML-probe response frame may include information regarding a first set of APs that is less than all the APs indicated by a ML-probe request. A subsequent ML-probe request may be communicated by the STA MLD to initiate a second ML-probe response frame including information regarding a second set of APs including one or more APs missing from the first set of APs. According to some aspects, a STA MLD or other non-AP MLD may compute or otherwise determine remaining information (such as one or more missing APs) missing from a ML-probe response frame. Additionally or alternatively, an AP MLD may compute or otherwise determine remaining information (such as one or more missing APs) missing from a ML-probe response frame.

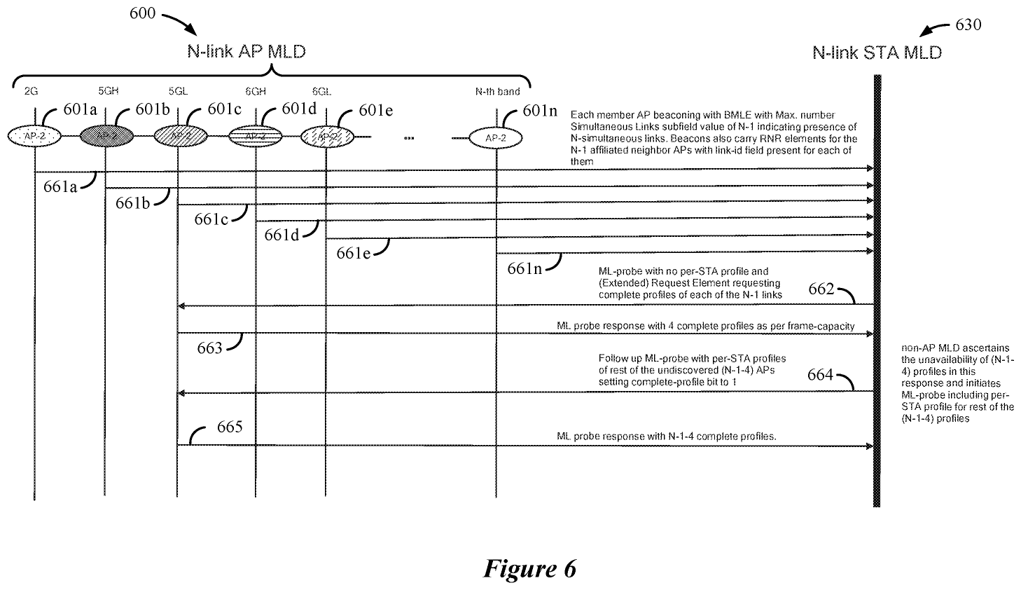

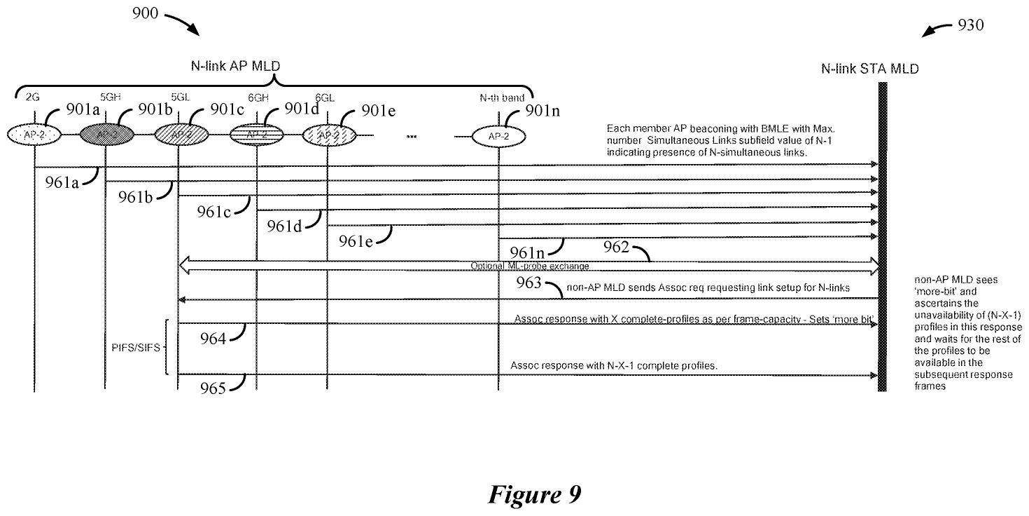

FIG. 6 shows a ladder diagram of MLO of an example in which a STA MLD making a ML-probe request regarding multiple APs determines remaining information missing from a corresponding ML-probe response frame for obtaining multiple ML-probe response frames according to some aspects of the present disclosure. The N-link AP MLD 600 of FIG. 6 may, for example, correspond to one or more of the APs 102 of FIG. 1, the AP MLD 300 of FIG. 3, any of the AP MLDs 400, 410, and 420 of FIG. 4, or any of the N-link AP MLDs 900, 1000, 1100 and 1200 of FIGS. 9, 10, 11, and 12. The N-link STA MLD 630 of FIG. 6 may, for example, correspond to one or more of the STAs 104 of FIG. 1 or any of the N-link STA MLDs 930, 1030, 1130, and 1230 of FIGS. 9, 10, 11, and 12.

In the illustrated example, each of APs 601a, 601b, 601c, 601d, 601c, and 601n affiliated with the N-link AP MLD 600 transmit (such as via a respective one of the 2G, 5GH, 5GL, 6GH, 6GL, and N^{th} band links), and the N-link STA MLD 630 receives (such as via respective ones of the 2G, 5GH, 5GL., 6GH, 6GL, and N^{th} band links), beacons (shown as signals 661a, 661b, 661c, 661d, 661e, and 661n respectively) having a basic multi-link element (BMLE) with a maximum number of simultaneous links subfield value of N−1 indicating the presence of N simultaneous links. The beacons may also carry RNR elements for the N−1 affiliated neighbor APs with a link identification field present for each of the N−1 affiliated neighbor APs.

The N-link STA MLD 630 of the example transmits (such as via the 5GL link), and the N-link AP MLD 600 receives (such as via the 5GL link by the AP 601c), a ML-probe request (shown as signal 662) for the complete profiles (in this example, N−1 profiles of the non-transmitting APs) of the AP MLD. For example, N-link MLO logic executed by the N-link STA MLD 630 may operate to control one or more transmitters of the N-link STA MLD 630 to transmit the ML-probe request. N-link MLO logic executed by the N-link AP MLD 600 may operate to control one or more receivers of the N-link AP MLD 600 to receive the ML-probe request. The ML-probe request may indicate a request for complete profiles of all the APs based at least in part on carrying no per-STA profile and a request element requesting complete profiles of each of the N−1 links. According to some examples, the ML-probe request may include one or more fields that identifies each AP for which the complete profiles are requested (such as may indicate each affiliated AP of the N-link AP MLD or some subset of APs).

In this example, a ML-probe response frame transmitted by the AP 601c via the 5GL link is constrained to include complete profile information for APs of up to 4 requested APs. According to examples, N-link MLO logic of the N-link AP MLD 600 may determine that the number (N−1) of requested APs indicated in the ML-probe request of the example is greater than the AP complete profile information constraint imposed with respect to the ML-probe response frame ((N−1)>4). In accordance with aspects herein, N-link MLO logic of the N-link AP MLD 600 determines or otherwise identifies a first set of APs of the APs requested for providing AP complete profiles, as per the per frame-capacity constraint. Accordingly, the N-link AP MLD 600 of the example transmits (such as via the 5GL link by the AP 601c), and the N-link STA MLD 630 receives (such as via the 5GL link), a ML-probe response (shown as signal 663) carrying AP complete profiles for a first set of APs of the APs requested, as per the per frame-capacity constraint. For example, N-link MLO logic of the N-link AP MLD 600 may operate to control one or more transmitters of the N-link AP MLD 600 to transmit the ML-probe response frame. N-link MLO logic of the N-link STA MLD 630 may operate to control one or more receivers of the N-link STA MLD 630 to receive the ML-probe response frame. In the example, the ML-probe response carries 4 complete AP profiles for a first set of 4 APs.

The N-link STA MLD 630 is operable according to aspects to ascertain or otherwise determine that complete profile information for one or more AP of the APs that were requested is missing from the ML-probe response frame. For example, N-link MIO logic executed by the N-link STA MLD 630 may analyze the ML-probe response frame and determine that complete profiles for one or more APs of the APs that were requested are not included. According to some aspects, N-link MLO logic of the N-link STA MLD 630 may know the value of N, such as from information obtained from a maximum number of simultaneous links subfield included in one or more beacons. Accordingly, the N-link MLO logic of the N-link STA MLD 630 may be operable use this information to determine or otherwise ascertain that (N−1)-4 APs complete profiles are yet to be discovered.

The 802.11 standards provide for a maximum number of simultaneous links subfield value in a MLD capabilities field. This maximum number of simultaneous links subfield value may be sufficient to indicate the value of N according to some examples herein. The maximum number of simultaneous links subfield in the MLD capabilities field, however, exists for purposes other than N-link MLO according to the examples of the present disclosure and thus instances of its conflicting use may be experienced. Accordingly, examples of the present disclosure may introduce a new field or subfield, or otherwise utilize a field/subfield specifically purposed for N-link MLO in accordance with concepts herein, to indicate the value of N. These examples may thus decouple the N-value from the above capability subfield.

The N-link STA MLD 630 is operable according to aspects to initiate one or more follow-up, subsequent, or second ML-probe response frames for obtaining AP complete profile information with respect to one or more APs of the APs that were requested in an initial ML-probe request. For example, the N-link STA MLD 630 may transmit (such as via the 5GL link), and the N-link AP MLD 600 receive (such as via the 5GL link by AP 601c), a follow-up, subsequent, or second ML-probe request (shown as signal 664) for the rest of the (N−1)-4 AP complete profiles. For example, N-link MLO logic of the N-link STA MLD 630 may operate to control one or more transmitters of the N-link STA MLD 630 to transmit the subsequent ML-probe request. N-link MLO logic of the N-link AP MLD 600 may operate to control one or more receivers of the N-link AP MLD 600 to receive the subsequent ML-probe request. According to some examples, a subsequent ML-probe request may indicate the missing APs for which AP complete profiles are yet to be discovered by the N-link STA MLD 630. A subsequent ML-probe request may, for example, include per-STA profiles for each of the (N−1)-4 APs and set the complete profile bit to 1 for each of the (N−1)-4 APs.

The N-link AP MLD 600 is operable according to aspects to provide one or more follow-up, subsequent, or second ML-probe response frames for providing AP complete profile information with respect to one or more APs of the APs that were requested in an initial or first ML-probe request. For example, N-link MLO logic executed by the N-link AP MLD 600 may analyze the subsequent ML-probe request to determine or otherwise identify a second set of APs (such as one or more of the (N−1)−4 APs missing from the initial ML-probe response frame) for providing AP complete profiles, as per the per frame-capacity constraint. Accordingly, the N-link AP MLD 600 of the example transmits (such as via the 5GL link by the AP 601c), and the N-link STA MLD 630 receives (such as via the 5GL link), a subsequent ML-probe response frame (shown as signal 665) carrying AP complete profiles for a second set of APs (such as with (N−1)−4 AP complete profiles) of the APs requested, as per the per frame-capacity constraint. According to aspects, the AP complete profiles for the second set of APs includes an AP complete profile for at least one AP responsive to the first ML-probe request that was missing from the AP complete profiles of the first ML-probe response frame. The N-link STA MLD 630 is thus enabled to obtain AP complete profile information regarding a second set of APs including one or more AP of the APs missing from the first set of APs, while each ML-probe response frame meets size constraints (such as a maximum data unit size) as may be imposed by communication protocols.

In the above example, having a per frame-capacity constraint of up to 4 AP complete profiles, the second ML-probe response frame may provide the AP complete profiles to result in AP complete profiles for all APs requested by the N-link STA MLD 630 where 5≤N≤9. Where the second ML-probe response frame cannot accommodate AP complete profiles for all APs missing from the first ML-probe response frame (such as where N≥10 in this example), one or more additional subsequent ML-probe response frames (such as a third ML-probe response frame, a fourth ML-probe response frame, and so on) may be initiated (such as by corresponding ones of a third ML-probe request, a fourth ML-probe request, and so on).

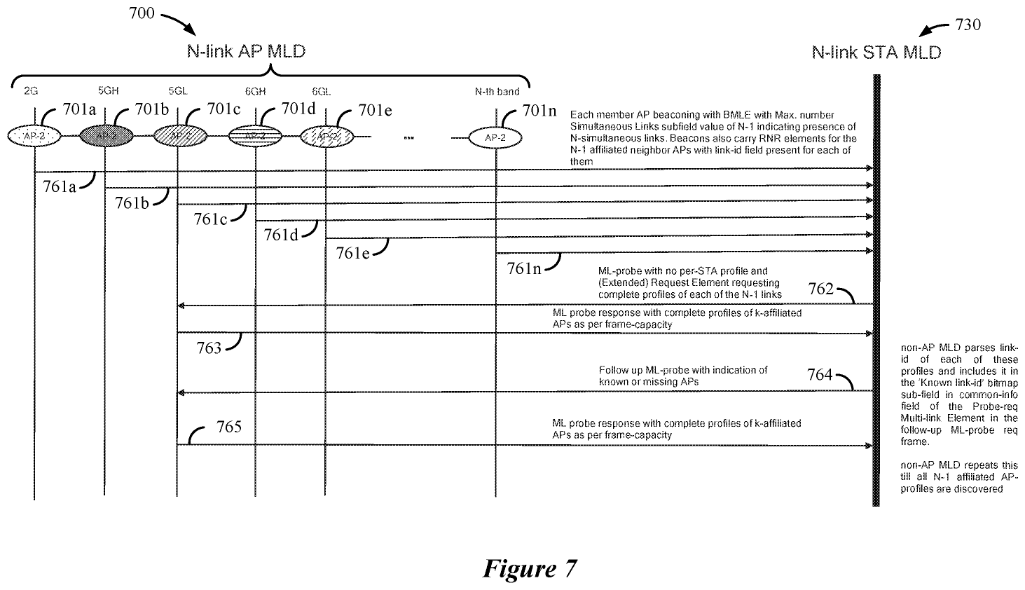

FIG. 7 shows a ladder diagram of MLO of another example in which a STA MLD making a ML-probe request regarding multiple APs determines remaining information missing from a corresponding ML-probe response frame for obtaining multiple ML-probe response frames according to some aspects of the present disclosure. The N-link AP MLD 700 of FIG. 7 may, for example, correspond to one or more of the APs 102 of FIG. 1, the AP MLD 300 of FIG. 3, any of the AP MLDs 400, 410, and 420 of FIG. 4, or any of the N-link AP MLDs 600, 1000, 1100 and 1200 of FIGS. 6, 10, 11, and 12. The N-link STA MLD 730 of FIG. 7 may, for example, correspond to one or more of the STAs 104 of FIG. 1 or any of the N-link STA MLDs 630, 1030, 1130, and 1230 of FIGS. 6, 10, 11, and 12.

In the illustrated example, each of APs 701a, 701b, 701c, 701d, 701e, and 701n affiliated with the N-link AP MLD 700 transmit (such as via a respective one of the 2G, 5GH, 5GL, 6GH, 6GL, and N^{th} band links), and the N-link STA MLD 730 receives (such as via respective ones of the 2G, 5GH, 5GL, 6GH, 6GL, and N^{th} band links), beacons (shown as signals 761a, 761b, 761c, 761d, 761e, and 761n respectively) having a BMLE with a maximum number of simultaneous links subfield value of N−1 indicating the presence of N simultaneous links. The beacons may also carry RNR elements for the N−1 affiliated neighbor APs with a link identification field present for each of the N−1 affiliated neighbor APs.

The N-link STA MLD 730 of the example transmits (such as via the 5GL link), and the N-link AP MLD 700 receives (such as via the 5GL link by the AP 701c), a ML-probe request (shown as signal 762) for the complete profiles (in this example, N−1 profiles of the non-transmitting APs) of the AP MLD. For example, N-link MLO logic executed by the N-link STA MLD 730 may operate to control one or more transmitters of the N-link AP MLD 730 to transmit the ML-probe request. N-link MLO logic executed by the N-link AP MLD 700 may operate to control one or more receivers of the N-link AP MLD 700 to receive the ML-probe request. The ML-probe request may indicate a request for complete profiles of all the APs based at least in part on carrying no per-STA profile and a request element requesting complete profiles of each of the N−1 links. According to some examples, the ML-probe request may include one or more fields that identifies each AP for which the complete profiles are requested (such as may indicate each affiliated AP of the N-link AP MLD or some subset of APs).

As with the previous example, a ML-probe response frame transmitted by the AP 701c via the 5GL link is constrained to include complete profile information for APs of up to 4 requested APs. N-link MLO logic executed by the N-link AP MLD 700 may determine that the number (N−1) of requested APs indicated in the ML-probe request of the example is greater than the AP complete profile information constraint imposed with respect to the ML-probe response frame ((N−1)>4). In accordance with aspects herein, N-link MLO logic of the N-link AP MLD 700 determines or otherwise identifies a first set of APs of the APs requested for providing AP complete profiles, as per the per frame-capacity constraint. Accordingly, the N-link AP MLD 700 transmits (such as via the 5GL link by the AP 701c), and the N-link STA MLD 730 receives (such as via the 5GL link), a ML-probe response (shown as signal 763) carrying complete AP profiles for a first set of APs of the APs requested, as per the per frame-capacity constraint. For example, N-link MLO logic of the N-link AP MLD 700 may operate to control one or more transmitters of the N-link AP MLD 700 to transmit the ML-probe response frame. N-link MLO logic of the N-link STA MLD 730 may operate to control one or more receivers of the N-link STA MLD 730 to receive the ML-probe response frame. In the example, the ML-probe response carries complete profiles of k-affiliated APs as per frame-capacity.

The N-link STA MLD 730 is operable according to aspects to ascertain or otherwise determine that complete profile information for one or more AP of the APs that were requested is missing from the ML-probe response frame. For example, N-link MLO logic executed by the N-link STA MLD 730 may parse or otherwise analyze link identification information (link-ID) of each profile included in the ML-probe response frame. Fach AP for which link-ID information is found to have been included in the ML-probe response frame may be determined by the N-link MLO logic to be an AP for which information has been discovered. Accordingly, the N-link MLO logic of the N-link STA MLD 730 may be operable use this information to determine or otherwise ascertain APs for which complete profiles are yet to be discovered.

The N-link STA MLD 730 is operable according to aspects to initiate one or more follow-up, subsequent, or second ML-probe response frames for obtaining AP complete profile information with respect to one or more APs of the APs that were requested in an initial ML-probe request. For example, the N-link STA MLD 730 may transmit (such as via the 5GL link), and the N-link AP MLD 700 receive (such as via the 5GL link by AP 701c), a follow-up, subsequent, or second ML-probe request (shown as signal 764) for one or more AP complete profiles. For example, N-link MLO logic executed by the N-link STA MLD 730 may operate to control one or more transmitters of the N-link AP MLD 600 to transmit the subsequent ML-probe request. N-link MLO logic of the N-link AP MLD 700 may operate to control one or more receivers of the N-link AP MLD 700 to receive the subsequent ML-probe request. According to some examples, a subsequent ML-probe request may indicate the missing APs for which AP complete profiles are yet to be discovered by the N-link STA MLD 730. According to some examples, a bit for each AP for which AP complete profile information has been received may be included in a known link-ID bitmap subfield (such as within a common information field) by operation of N-link MLO logic of the N-link STA MLD 730. A known link-ID bitmap subfield may, for example, carry a bitmap (such as a 16 bit bitmap) of set-bits of which will provide the link-IDs for which a complete profile has already been received by the N-link STA MLD 730. A known link-ID bitmap, or other indication of APs for which AP complete profiles are yet to be discovered may be included in one or more subsequent ML-probe requests.

The N-link AP MLD 700 is operable according to aspects to provide one or more follow-up, subsequent, or second ML-probe response frames for providing AP complete profile information with respect to one or more APs of the APs that were requested in an initial or first ML-probe request. For example, N-link MLO logic executed by the N-link AP MLD 700 may analyze the subsequent ML-probe request to determine or otherwise identify a second set of APs (such as an additional k-affiliated APs missing from the initial ML-probe response frame) for providing AP complete profiles, as per the per frame-capacity constraint. Accordingly, the N-link AP MLD 700 of the example transmits (such as via the 5GL link by the AP 701c), and the N-link STA MLD 730 receives (such as via the 5GL link), a subsequent ML-probe response frame (shown as signal 765) carrying AP complete profiles for a second set of APs (such as with up to an additional k-affiliated APs) of the APs requested, as per the per frame-capacity constraint. For example, N-link MLO logic executed by the N-link AP MLD 700 may operate to control one or more transmitters of the N-link AP MLD 700 to transmit the subsequent ML-probe response frame. N-link MLO logic of the N-link STA MLD 730 may operate to control one or more receivers of the N-link STA MLD 730 to receive the subsequent ML-probe response frame. According to aspects, the AP complete profiles for the second set of APs includes an AP complete profile for at least one AP responsive to the first ML-probe request that was missing from the AP complete profiles of the first ML-probe response frame. The N-link STA MLD 730 is thus enabled to obtain AP complete profile information regarding a second set of APs including one or more AP of the APs missing from the first set of APs, while each ML-probe response frame meets size constraints as may be imposed by communication protocols.

In the examples of FIGS. 6 and 7, the initial or first ML-probe request (signals 662 and 762), the initial or first ML-probe response frame (signals 663 and 763), the subsequent or second ML-probe request (signals 664 and 764), and the subsequent or second ML-probe response frame (signals 665 and 765) aggregate to provide respective N-link ML-probe sessions in which information with respect to multiple APs is communicated between the N-link AP MLDs 600 and 700 and the N-link STA MLDs 630 and 730 within applicable size constraints. The associated signals of a N-link ML-probe session of these examples may continue so as to provide AP complete profiles for all APs requested by the respective N-link STA MLD 630 and 730. For example, the N-link STA MLD 630 and 730 may repeatedly transmit subsequent ML-probe requests, and the N-link AP MD 600 and 700 repeatedly transmit subsequent ML-probe response frames until AP complete profiles are discovered for all APs that are requested. According to some examples, a N-link ML-probe session may terminate after transmission and reception of a subsequent ML-probe request and corresponding subsequent ML-probe response frame but prior to AP complete profiles for all APs that are requested being discovered. For example, a N-link STA MLD or other non-AP MLD may terminate a N-link ML-probe session after having received AP complete profiles for APs sufficient for implementing MLO having desired attributes (such as providing desired throughput, latency, etc.), after having received a AP complete profile for one or more particular AP or link (such as for establishing a desired multi-link combination from among 2G, 5GH, 5GL, 6GH, 6GL, and N^{th} band links), etc.

The examples of FIGS. 6 and 7 above are described with reference to a N-link STA MLD or other non-AP MLD providing subsequent ML-probe requests indicating one or more AP of the APs that were requested is missing from the ML-probe response frame. According to some aspects, an AP MLD may compute or otherwise determine remaining information missing from a ML-probe response. A N-link STA MLD or other non-AP MLD of some examples may thus provide subsequent ML-probe requests without indicating APs that were requested is missing from the ML-probe response frame. For example, the N-link STA MLD 630 of FIG. 6 may transmit, and the N-link AP MLD 600 may receive, a subsequent ML-probe request (signal 664) to initiate transmission of one or more subsequent ML-probe response frames (signal 665) without indicating the missing APs for which AP complete profiles are yet to be discovered by the N-link STA MLD 630. As another example, the N-link STA MLD 730 of FIG. 7 may transmit, and the N-link AP MLD 700 may receive, a subsequent ML-probe request (signal 764) to initiate transmission of one or more subsequent ML-probe response frames (signal 765) without indicating the missing APs for which AP complete profiles are yet to be discovered by the N-link STA MLD 730. The N-link AP MLDs 600 and 700 may compute the remaining information. For example, N-link MLO logic executed by the N-link AP MLDs 600 and 700 may store information regarding the subset of affiliated APs whose complete profiles were included in previous ML-probe response frame(s). The N-link MLO logic may analyze this information to determine or otherwise identify remaining APs (such as a second set of APs) to include in subsequent ML-probe response frames (such as signals 665 and 765).

According to some examples, one or more ML-probe response frame of a N-link ML-probe session may include an indication that the ML-probe response frame does not include AP complete profiles for all APs that were requested. For example, N-link MLO logic executed by the N-link AP MLDs 600 and 700 may operate to cause an indicator (such as a bit in a ML-probe response incomplete subfield, a bitmap which will provide the link-IDs for which a complete profile has been transmitted, etc.) to be included in the initial ML-probe response frame (signals 663 and 763) to provide an indication to the N-link STA MLDs 630 and 730 that the first set of APs is less than all APs that are requested. The N-link MLO logic may additionally or alternatively operate to cause an indicator to be included in one or more subsequent ML-probe response frames (signals 665 and 765) to provide an indication to the N-link STA MLDs 630 and 730 that complete profiles for the all APs that are requested has not been completed or that one or more AP complete profiles remain to be discovered by the N-link STA MLDs.

An indication that the ML-probe response frame does not include AP complete profiles for all APs that were requested may be used by the N-link STA MLDs 630 and 730 in determining that one or more AP of the APs that are requested is missing from the ML-probe response frame. For example, N-link MLO logic executed by the N-link STA MLDs 630 and 730 may ascertain or otherwise determine that complete profile information for one or more AP of the APs that were requested is missing from the ML-probe response frame based at least in part on detecting or analyzing an indicator regarding the ML-probe response frame not including AP complete profiles for all APs that are requested.

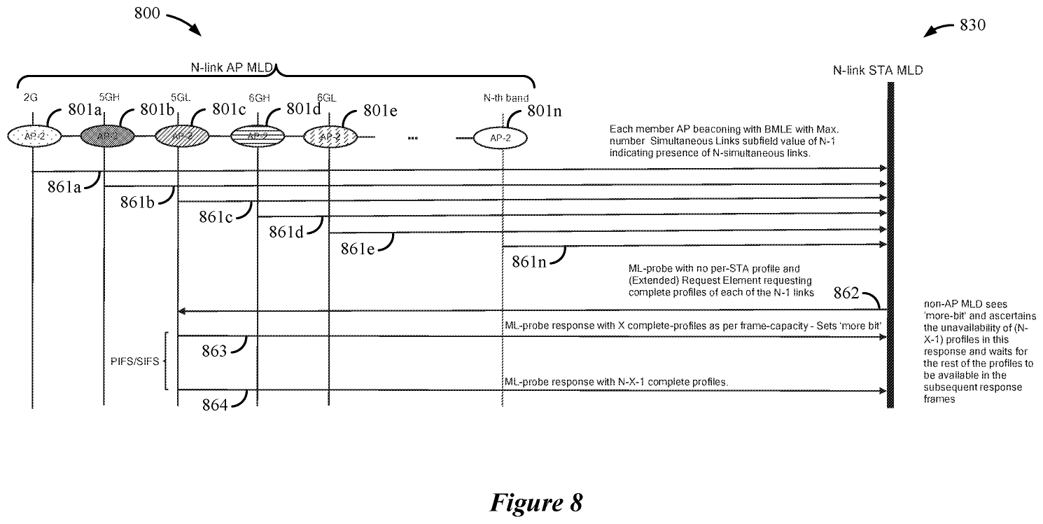

FIG. 8 shows a ladder diagram of MLO of an example in which an AP MLD providing a subsequent ML-probe response frame regarding multiple APs determines remaining information missing from an initial ML-probe response frame for providing multiple ML-probe response frames according to some aspects of the present disclosure. The N-link AP MLD 800 of FIG. 8 may, for example, correspond to one or more of the APs 102 of FIG. 1, the AP MLD 300 of FIG. 3, or any of the AP MLDs 400, 410, and 420 of FIG. 4, or any of the N-link AP MLDs 600, 700, 1100 and 1200 of FIGS. 6, 7, 11, and 12. The N-link STA MLD 830 of FIG. 8 may, for example, correspond to one or more of the STAs 104 of FIG. 1 or any of the N-link STA MLDs 630, 730, 1130, and 1230 of FIGS. 6, 7, 11, and 12.

In the illustrated example, each of APs 801a, 801b, 801c, 801d, 801e, and 801n affiliated with the N-link AP MLD 800 transmit (such as via a respective one of the 2G, 5GH, 5GL, 6GH, 6GL, and N^{th} band links), and the N-link STA MLD 830 receives (such as via respective ones of the 2G, 5GH, 5GL, 6GH, 6GL, and N^{th} band links), beacons (shown as signals 861a, 861b, 861c, 861d, 861e, and 861n respectively) having a BMLE with a maximum number of simultaneous links subfield value of N−1 indicating the presence of N simultaneous links.

The N-link STA MLD 830 of the example transmits (such as via the 5GL link), and the N-link AP MLD 800 receives (such as via the 5GL link by the AP 801c), a ML-probe request (shown as signal 862) for the complete profiles (in this example, N−1 profiles of the non-transmitting APs) of the AP MLD. For example, N-link MLO logic executed by the N-link STA MLD 830 may operate to control one or more transmitters of the N-link STA MLD 830 to transmit the ML-probe request. N-link MLO logic executed by the N-link AP MLD 800 may operate to control one or more receivers of the N-link AP MLD 800 to receive the ML-probe request. The ML-probe request may indicate a request for complete profiles of all the APs based at least in part on carrying no per-STA profile and a request element requesting complete profiles of each of the N−1 links. According to some examples, the ML-probe request may include one or more fields that identifies each AP for which the complete profiles are requested (such as may indicate each affiliated AP of the N-link AP MLD or some subset of APs).

Similar to previous examples, a ML-probe response frame transmitted by the AP 801c via the 5GL link is constrained to include complete profile information for APs of up to X requested APs. N-link MIO logic executed by the N-link AP MLD 800 may determine that the number (N−1) of requested APs indicated in the ML-probe request of the example is greater than the AP complete profile information constraint imposed with respect to the ML-probe response frame ((N−1)>X). In accordance with aspects herein, N-link MLO logic of the N-link AP MLD 800 determines or otherwise identifies a first set of APs of the APs requested for providing AP complete profiles, as per the per frame-capacity constraint. Accordingly, the N-link AP MLD 800 transmits (such as via the 5GL link by the AP 801c), and the N-link STA MLD 830 receives (such as via the 5GL link), a ML-probe response frame (shown as signal 863) carrying complete AP profiles for a first set of APs of the APs requested, as per the per frame-capacity constraint. For example, N-link MLO logic of the N-link AP MLD 800 may operate to control one or more transmitters of the N-link AP MLD 800 to transmit the ML-probe response frame. N-link MLO logic of the N-link STA MLD 830 may operate to control one or more receivers of the N-link STA MLD 830 to receive the ML-probe response frame. In the example, the ML-probe response frame carries X complete profiles as per frame-capacity.

The ML-probe response frame of examples includes an indication that the ML-probe response frame does not include AP complete profiles for all APs that were requested. For example, N-link MLO logic executed by the N-link AP MLD 800 may operate to cause an indicator (such as a bit in a more subfield, etc.) to be included in the ML-probe response frame (signal 863) to provide an indication to the N-link STA MLD 830 that the first set of APs is less than all APs that are requested.

The N-link STA MLD 830 is operable according to aspects to ascertain or otherwise determine that one or more APs is missing from the first set of APs of the ML-probe response frame, and in response may await one or more follow-up or subsequent ML-probe response frames. For example, N-link MLO logic executed by the N-link STA MLD 830 may ascertain or otherwise determine that complete profile information for one or more AP of the APs that were requested is missing from the ML-probe response frame based at least in part on detecting or analyzing an indicator regarding the ML-probe response frame not including AP complete profiles for all APs that are requested.

The N-link AP MLD 800 is operable according to aspects to provide one or more follow-up, subsequent, or second ML-probe response frames for providing AP complete profile information with respect to one or more APs of the APs that were requested in an initial or first ML-probe request. For example, N-link MLO logic executed by the N-link AP MLD 800 may store information regarding the subset of affiliated APs whose complete profiles were included in ML-probe response frame(s). The N-link MLO logic may analyze this information to determine or otherwise identify remaining APs to include in subsequent ML-probe response frames.

In the example of FIG. 8, N-link MLO logic of N-link AP MLD 800 may determine or otherwise identify a second set of APs (such as one or more of the (N−1)−X APs missing from the initial ML-probe response frame) for providing AP complete profiles, as per the per frame-capacity constraint. Accordingly, the N-link AP MLD 800 of the example transmits (such as via the 5GL link by the AP 801c), and the N-link STA MLD 830 receives (such as via the 5GL link), a subsequent ML-probe response frame (shown as signal 864) carrying AP complete profiles for a second set of APs (such as with (N−1)−X AP complete profiles) of the APs requested, as per the per frame-capacity constraint. For example, N-link MLO logic executed by the N-link AP MLD 800 may operate to control one or more transmitters of the N-link AP MLD 800 to transmit the subsequent ML-probe response frame. N-link MLO logic of the N-link STA MLD 830 may operate to control one or more receivers of the N-link STA MLD 830 to receive the subsequent ML-probe response frame. According to aspects, the AP complete profiles for the second set of APs includes an AP complete profile for at least one AP responsive to the first ML-probe request that was missing from the AP complete profiles of the first ML-probe response frame. The N-link STA MLD 830 is thus enabled to obtain AP complete profile information regarding a second set of APs including one or more AP of the APs missing from the first set of APs, while each ML-probe response frame meets size constraints (such as a maximum data unit size) as may be imposed by communication protocols. The first ML-probe response frame (signal 863) and the second ML-probe response frame (signal 864) of this example are received in association with the ML-probe first request (signal 862) without transmission of a second ML-probe request regarding the at least one AP.

In the above example, having a per frame-capacity constraint of up to X AP complete profiles, the second ML-probe response frame may provide the AP complete profiles to result in AP complete profiles for all APs requested by the N-link STA MLD 830 where X≤N≤(2X+1). Where the second ML-probe response frame cannot accommodate AP complete profiles for all APs missing from the first ML-probe response frame (such as where N≥(2X+1) in this example), one or more additional subsequent ML-probe response frames (such as a third ML-probe response frame, a fourth ML-probe response frame, and so on) may be initiated. According to aspects, ML-probe response frames for which a subsequent ML-probe response frame will follow include an indication that the ML-probe response frame does not include AP complete profiles for all APs that were requested. For example, N-link MLO logic executed by the N-link AP MLD 800 may operate to cause an indicator (such as a bit in a more subfield, etc.) to be included in the subsequent ML-probe response frame (signal 864) to provide an indication to the N-link STA MLD 830 that the first and second sets of APs is less than all APs that are requested and thus a third ML-probe response frame may be provided.

According to some examples, the N-link ML-probe session of the example of FIG. 8 may terminate after transmission and reception of a subsequent ML-probe response frame, but prior to AP complete profiles for all APs that are requested being discovered. For example, the N-link AP MLD 800 may terminate a N-link ML-probe session after having transmitted AP complete profiles for one or more particular AP or link (such as for establishing a desired multi-link combination from among 2G, 5GH, 5GL, 6GH, 6GL, and N^{th} band links). A hybrid technique (such as combining aspects of the example of FIG. 8 with the examples of FIGS. 6 and 7) may be implemented according to some aspects in which the N-link STA MLD 830 may initiate one or more follow-up or subsequent ML-probe response frames for obtaining AP complete profile information with respect to one or more APs. For example, the N-link STA MLD 830 may transmit (such as via the 5GL link), and the N-link AP MLD 800 receive (such as via the 5GL link by AP 801c), a ML-probe request for one or more AP complete profiles for implementing MLO having desired attributes (such as providing desired throughput, latency, for establishing a desired multi-link combination from among 2G, 5GH, 5GL, 6GH, 6GL, and N^{th} band links, etc.).

ML-probe response frames (signals 863 and 864) of the N-link ML-probe session in the example of FIG. 8 may be transmitted according to a known schedule or periodicity or otherwise separated in time sufficiently for reception and use by a N-link STA MLD or other non-AP MLD. For example, ML-probe response frames of a N-link ML-probe session may be short interframe space (SIFS) or point coordination function (PCF) interframe space (PIFS) separated according to aspects.

Examples above (such as the examples referencing FIGS. 6, 7, and 8) are described with reference to ML-probe requests and ML-probe response frames of N-link probe sessions. It should be understood, however, that concepts of those examples and as otherwise presented by the present disclosure are not limited to application with respect to ML-probe requests and ML-probe response frames. By way of example, the exchange of MLO information via ML-(re)association requests and ML-(re)association response frames may be burdened with information with respect to a large number of APs affiliated with the AP MLD. Accordingly, concepts of the present disclosure may be implemented with respect to N-link ML-(re)association requests and ML-(re)association response frames of N-link MLO. ML-(re)association requests and ML-(re)association response frames may, for example, be the requests and response frames referenced above with respect to the examples of FIGS. 6, 7, and 8, in N-link MLO operation according to some aspects of the disclosure.

In N-link MLO according to aspects of the disclosure, a one or more ML-(re)association-response frames carry the complete-profiles of all the requested APs. For example, operation enables transmitting and receiving multiple ML-(re)association response frames when a N-link AP MLD does not include information regarding all the APs requested by a N-link STA MLD in an initial ML-association response frame (such as when the size of a ML-(re)association response frame including information regarding all the APs would exceed one or more frame size constraints).

FIG. 9 shows a ladder diagram of MLO of an example in which an AP MLD provides multiple ML-(re)association response frames according to some aspects of the present disclosure. The N-link AP MLD 900 of FIG. 9 may, for example, correspond to one or more of the APs 102 of FIG. 1, the AP MLD 300 of FIG. 3, any of AP MLDs 400, 410, and 420 of FIG. 4, or any of the N-link AP MLDs 600, 700, 800, and 1200 of FIGS. 6, 7, 8, and 12. The N-link STA MLD 930 of FIG. 9 may, for example, correspond to one or more of the STAs 104 of FIG. 1 or any of the N-link STA MLDs 630, 730, 830, and 1230 of FIGS. 6, 7, 8, and 12. The example of FIG. 9 provides for subsequent PIFS or SIFS separated ML-(re)association frames containing the remaining per-STA profiles that are not carried in prior ML-(re)association frames.

In the illustrated example, each of APs 901a, 901b, 901c, 901d, 901e, and 901n affiliated with the N-link AP MLD 900 transmit (such as via a respective one of the 2G, 5GH, 5GL, 6GH, 6GL, and N^{th} band links), and the N-link STA MLD 930 receives (such as via respective ones of the 2G, 5GH, 5GL, 6GH, 6GL, and N^{th} band links), beacons (shown as signals 961a, 961b, 961c, 961d, 961e, and 961n respectively) having a BMLE with a maximum number of simultaneous links subfield value of N−1 indicating the presence of N simultaneous links.

The N-link AP MLD 900 and the N-link STA MLD 930 of the example operate to implement a N-link ML-probe session (shown as signals 962) in the example of FIG. 9. For example, a N-link ML-probe session may be implemented in accordance with any of the examples discussed above with reference to FIGS. 6, 7, 8, and 9. In accordance with the N-link ML-probe session, the N-link STA MLD 930 may transmit (such as via one or more of the 2G, 5GH, 5GL., 6GH, 6GL., . . . . N^{th} band links), and the N-link AP MLD 900 may receive (such as via one or more of the 2G, 5GH, 5GL, 6GH, 6GL, . . . . N^{th} band links), a ML-probe request for the complete profiles of the AP MLD. In response, the N-link AP MLD 900 may transmit (such as via one or more of the 2G, 5GH, 5GL, 6GH, 6GL, . . . . N^{th} band links), and the N-link STA MLD 930 may receive (such as via one or more of the 2G, 5GH, 5GL, 6GH, 6GL, . . . . N^{th} band links), one or more ML-probe response frames.

The N-link STA MLD 930 of the example transmits (such as via the 5GL link), and the N-link AP MLD 900 receives (such as via the 5GL link by the AP 901c), a ML-(re)association request (shown as signal 963) for link setup for N links. In this example, a ML-(re)association response frame transmitted by the AP 901c via the 5GL link is constrained to include complete profile information for APs of up to X requested APs. For example, N-link MLO logic executed by the N-link STA MLD 930 may operate to control one or more transmitters of the N-link STA MLD 930 to transmit the ML-(re)association request. N-link MLO logic executed by the N-link AP MLD 900 may operate to control one or more receivers of the N-link AP MLD 900 to receive the ML-(re)association request. N-link MLO logic executed by the N-link AP MLD 900 may determine that the number of requested APs indicated in the ML-(re)association request of the example is greater than the AP complete profile information constraint imposed with respect to the ML-(re)association response frame.

In accordance with aspects herein, N-link MLO logic of the N-link AP MLD 900 determines or otherwise identifies a first set of APs of the APs requested, as per the per frame-capacity constraint. Accordingly, the N-link AP MLD 900 transmits (such as via the 5GL link by the AP 901c), and the N-link STA MLD 930 receives (such as via the 5GL link), a ML-(re)association response frame (shown as signal 964) carrying complete AP profiles for a first set of APs of the APs requested, as per the per frame-capacity constraint. For example, N-link MLO logic of the N-link AP MLD 900 may operate to control one or more transmitters of the N-link AP MLD 900 to transmit the ML-(re)association response frame. N-link MLO logic executed by the N-link STA MLD 930 may operate to control one or more receivers of the N-link STA MLD 930 to receive the ML-(re)association response frame. In the example, the ML-(re)association response frame carries X complete profiles as per frame-capacity.

The ML-(re)association response frame of examples includes an indication that the ML-(re)association response frame does not include AP complete profiles for all APs that were requested. For example, N-link MLO logic executed by the N-link AP MLD 900 may operate to cause an indicator (such as a bit in a more subfield, etc.) to be included in the ML-(re)association response frame (signal 964) to provide an indication to the N-link STA MLD 930 that the first set of APs is less than all APs that are requested. The N-link AP MLD 900 may additionally or alternatively use a maximum number of simultaneous links subfield value in this context.

The N-link STA MLD 930 is operable according to aspects to ascertain or otherwise determine that one or more APs is missing from the first set of APs of the ML-(re)association response frame, and in response may await one or more follow-up or subsequent ML-(re)association response frames. For example, N-link MLO logic executed by the N-link STA MLD 930 may ascertain or otherwise determine that complete profile information for one or more AP of the APs that were requested is missing from the ML-(re)association response frame based at least in part on detecting or analyzing an indicator regarding the ML-(re)association response frame not including AP complete profiles for all APs that are requested. The N-link STA MLD 930 may additionally or alternatively use a maximum number of simultaneous links subfield value in this context.

The N-link AP MLD 900 is operable according to aspects to provide one or more follow-up, subsequent, or second ML-(re)association response frames for providing AP complete profile information with respect to one or more APs of the APs that were requested in an initial or first ML-(re)association request. For example, N-link MLO logic executed by the N-link AP MLD 900 may store information regarding the subset of affiliated APs whose complete profiles were included in ML-(re)association response frame(s). The N-link MLO logic may analyze this information to determine or otherwise identify remaining APs to include in subsequent ML-(re)association response frames.

In the example of FIG. 9, N-link MLO logic of N-link AP MLD 900 may determine or otherwise identify a second set of APs (such as one or more of the (N−1)−X APs missing from the initial ML-(re)association response frame) for providing AP complete profiles, as per the per frame-capacity constraint. Accordingly, the N-link AP MLD 900 of the example transmits (such as via the 5GL link by the AP 901c), and the N-link STA MLD 930 receives (such as via the 5GL link), a subsequent ML-(re)association response frame (shown as signal 965) carrying AP complete profiles for a second set of APs of the APs requested, as per the per frame-capacity constraint. For example, N-link MLO logic executed by the N-link AP MLD 900 may operate to control one or more transmitters of the N-link AP MLD 900 to transmit the subsequent ML-(re)association response frame. N-link MLO logic executed by the N-link STA MLD 930 may operate to control one or more receivers of the N-link STA MLD 930 to receive the subsequent ML-(re)association response frame. According to aspects, the AP complete profiles for the second set of APs includes an AP complete profile for at least one AP responsive to the first ML-(re)association request that was missing from the AP complete profiles of the first ML-(re)association response frame. The N-link STA MLD 930 is thus enabled to obtain AP complete profile information regarding a second set of APs including one or more AP of the APs missing from the first set of APs, while each ML-(re)association response frame meets size constraints (such as a maximum data unit size) as may be imposed by communication protocols.

In the above example, having a per frame-capacity constraint of up to X AP complete profiles, the second ML-(re)association response frame may provide the AP complete profiles to result in AP complete profiles for all APs requested by the N-link STA MLD 930 where X<N≤(2X+1). Where the second ML-(re)association response frame cannot accommodate AP complete profiles for all APs missing from the first ML-(re)association response frame (such as where N≥(2X+1) in this example), one or more additional subsequent ML-(re)association response frames (such as a third ML-probe response frame, a fourth ML-probe response frame, and so on) may be initiated. In some examples, the N-link STA MLD 930 may wait until profiles for all requested links are received, possibly in multiple ML-association response frames, and may accomplish the link setup upon receiving all of them.

ML-(re)association response frames (signals 964 and 965) of the N-link ML-(re)association session in the example of FIG. 9 may be transmitted according to a known schedule or periodicity or otherwise separated in time sufficiently for reception and use by a N-link STA MLD or other non-AP MLD. For example, ML-(re)association response frames of a N-link ML-(re)association session may be SIFS or PIFS separated according to aspects.

Examples above (such as the examples referencing FIGS. 6, 7, 8, and 9) are described above with reference to N-link requests (such as ML-probe request and ML-(re)association requests) and response frames (such as ML-probe response frames or ML-(re)association response frames) being communicated via 5GL, links. It should be understood, however, that the particular links indicated in the examples are illustrative of the various links that may be used in N-link MLO according to concepts herein. Accordingly, the particular link or links (such as one or more of 2G, 5GH, 5GL, 6GH, 6GL, . . . . N^{th} band links) utilized in N-link MLO operation may be other than the 5GL links shown in the examples. In some examples, a N-link AP MLD or N-link STA MLD may select one or more aspect (such as one or more 2G, 5GH, 5GL, 6GH, 6GL, . . . . N^{th} band links, PDU configurations, etc.) of communication links for use with respect to communication of either or both of the N-link requests and response frames of N-link request and response sessions (such as the N-link ML-probe sessions of the examples of FIGS. 6, 7, and 8 above, and the N-link ML-(re)association session of FIG. 9 above).

The examples of FIGS. 6, 7, 8, and 9 are described above with reference to beacons providing information with respect to a maximum number of N simultaneous links, such as by including a BMLE with a maximum number of simultaneous links subfield value of N−1. Some examples may implement additional or alternative techniques for providing information regarding a maximum number of N simultaneous links. For example, a N-link AP MLD may transmit an indication of a maximum number of N simultaneous links by various means, such as via a subfield added according to the 802.11 standards for this purpose.

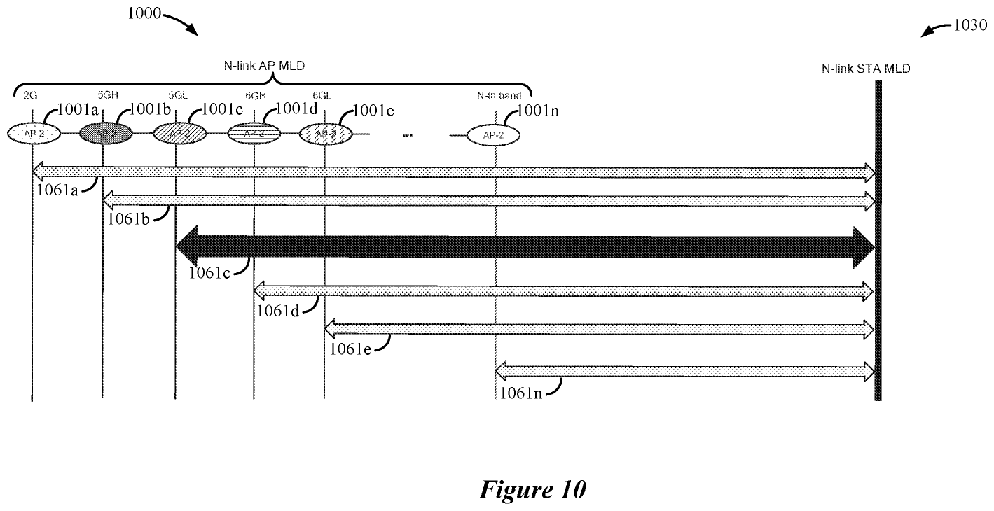

In operation according to some examples, one or more aspect of a communication link is selected for communication of either or both of N-link requests (such as ML-probe requests, ML-(re)association requests, etc.) and response frames (such as ML-probe response frames, ML-(re)association response frames, etc.). FIG. 10 shows a communication link diagram illustrating an example in which a N-link MLD may select a communication link for a N-link request and response session according to some aspects of the present disclosure. The N-link AP MLD 1000 of FIG. 10 may, for example, correspond to one or more of the APs 102 of FIG. 1, the AP MLD 300 of FIG. 3, any of the AP MLDs 400, 410, and 420 of FIG. 4, or any of the N-link AP MLDs 600, 700, 800, and 900 of FIGS. 6, 7, 8, and 9. The N-link STA MLD 1030 of FIG. 10 may, for example, correspond to one or more of the STAs 104 of FIG. 1 or any of the N-link STA MLDs 730, 830, and 930 of FIGS. 6, 7, 8, and 9. Links 1061a, 1061b, 1061c, 1061d, 1061e, and 1061n may be representative of the communication links as may be utilized with respect to communication of either or both of N-link requests and response frames between the N-link AP MLD 1000 (such as by respective ones of APs 1001a, 1001b, 1001c, 1001d, 1001e, and 1001n affiliated with the N-link AP MLD 1000) and the N-link STA MLD 1030.

According to some aspects, channel conditions, location of APs affiliated with the N-link AP MLD 1000 (such as may correspond to any or all of N-link AP MLDs 600, 700, 800, and 900) relative to the N-link STA MLD 1030 (such as may correspond to any or all of N-link STA MLDs 630, 730, 830, and 930), channel congestion, etc., may result in links having attributes with varying levels of desirability for use with respect to communication of a N-link request (whether a N-link ML-probe request, a N-link ML-(re)association request, etc.), a response frame (whether a ML-probe response frame, a ML-(re)association response frame, etc.), or a combination thereof. One or more link attributes may, for example, be determined using or based upon monitoring aspects of a beacon or reference signal, referencing historical communication information, measuring signal attributes (such as signal to noise, power level, error rate, etc.), or combinations thereof. According to some aspects, N-link MLO logic executed by the N-link AP MLD 1000, the N-link STA MLD 1030, or both may operate to determine one or more link attributes (such as may be relevant to desirability for use in communication of a N-link request or a response frame) with respect to any or all of links 1061a, 1061b, 1061c, 1061d, 1061e, and 1061n available to the MLDs.

In the example of FIG. 10, link 1061c (such as may correspond to a 5GL link between the AP 1001c and the N-link STA MLD 1030) provides one or more desirable attributes with respect to communication of a N-link request, a response frame, or a combination thereof. For example, link 1061c may support one or more of a modulation and coding scheme (MCS), bandwidth, number of spatial streams, etc. facilitating either or both of a N-link request and a response frame carrying information for a relatively large number of APs (such as may be sufficient in number to avoid transmission of one or more subsequent ML-probe response frames). Desirability of link attributes for use with respect to communication of a N-link request or a response frame may, for example, be determined by comparison to threshold or otherwise established values. Additionally or alternatively, desirability of link attributes for use with respect to communication of a N-link request or a response frame may be determined by comparison to corresponding attributes of one or more of the other links. N-link MLDs of some examples may determine a link having desirable attributes (such as a “best” link) by intersecting its own capabilities with that of the corresponding N-link MLD link-wise. For example, a N-link STA MLD may build a full profile of the target N-link AP MLD (such as by discovering all the beacons from each link, by ML-probe exchanges, etc.) for use with respect to determining a for use in communication of N-link requests and response frames.

In some examples, N-link MLO logic executed by the N-link AP MLD 1000, the N-link STA MLD 1030, or both operate to select a particular link (such as a link of links 1061a, 1061b, 1061c, 1061d, 1061e, and 1061n available to the MLDs) as having one or more attributes facilitating transmission of response frames to include information regarding multiple APs affiliated with the N-link AP MLD 1000. Effective selection of a link according to aspects enables the N-link AP MLD 1000 to transmit a larger content in the response frame than what may otherwise be accommodated if the frame is transmitted with a non-HT rate.

N-link STA MLD 1030 of some examples may select a particular link as having one or more attributes facilitating transmission of response frames and transmit a N-link request via the selected link. The one or more attributes may for example, be one or more of a MCS rate, a bandwidth, or a number of spatial streams. The N-link STA MLD 1030 may indicate selection of a link to the N-link AP MLD 1000, such as by using the selected link to transmit a N-link request, including an indication of the selected link in a N-link request, etc.

The N-link AP MLD 1000 may additionally or alternatively select a particular link as having one or more attributes facilitating transmission of response frames and transmit a response frame via the selected link. The one or more attributes may for example, be one or more of a MCS rate, a bandwidth, or a number of spatial streams. Selection of a particular link by the N-link AP MLD 1000 for transmission of a response frame, according to some aspects, may be performed in a case where the N-link STA MLD 1030 does not otherwise select a particular link with respect to the N-link request and response session or may be performed in addition to the N-link STA MLD 1030 selecting a particular link (such as to confirm or override a link selection made by the N-link STA MLD 1030). The N-link AP MLD 1000 may indicate selection of a link to the N-link STA MLD 1030, such as by using the selected link to transmit a response frame, by ordering the link identification information in an order based on one or more attributes facilitating transmission of response frames (such as ranked based on one or more of MCS rate, bandwidth, number of spatial streams, etc.), etc. According to an example, the N-link AP MLD 1000 may rank the links as Link 1<Link 2<Link 3 (such as where Link 1, Link 2, and Link 3 are each a particular one of links 1061a, 1061b, 1061c, 1061d, 1061e, and 1061n available to the MLDs) and the N-link STA MLD 1030 may be capable of using Link 1 and Link 2. In this example, the N-link STA MLD 1030 may expect the response in Link 2. That is, the response is expected in the best link chosen from the ordered set of links relevant for the non-AP MLD.

According to some aspects, use of a link selected by the N-link STA MLD 1030, the N-link AP MLD 1000, or both may facilitate the response frames carrying information for a relatively large number of APs (such as may be sufficient in number to avoid transmission of one or more subsequent ML-probe response frames). For example, a selected link may enable the N-link AP MLD 1000 to transmit a larger content in the ML-probe response frame than what may be accommodated if the frame is transmitted with a non-HT rate in a very high throughput (VHT), high efficiency (HE), or extremely high throughput (EHT) PPDU in accordance with the IEEE 802.11be amendment to the IEEE 802.11 family of wireless communication protocol standard.

According to some aspects, if the N-link AP MLD 1000 uses a higher MCS rate, bandwidth, spatial stream, etc. combination to transmit a ML-probe response frame via a link selected for one or more of these attributes, the N-link AP MLD 1000 may set the A1 field to that of the requesting non-AP MLD (in this example the N-link STA MLD 1030). Accordingly, the ML-probe response frame may be unicast, such as to ensure retransmissions in case of error. According to aspects, a N-link ML-(re)association response frame is a unicast frame, and thus may be robust enough by means of retransmissions even if sent with higher-rate parameters according to the above link selection technique.

In some examples, various combinations of MCS rate, bandwidth, spatial stream, etc. for non-VHT and non-HE PPDUs may be provided for in order to support transmission of N-link requests, response frames, or combinations thereof carrying information for a relatively large number of APs in N-link MIO. For example, 802.11 standards may be modified to provide for increased MMPDU-limits for certain MCS, bandwidth, spatial stream, etc. combinations (such as to increase maximum MMPDU size for non-HT PPDU if the PPDU is sent at 54 Mbps) for non-VHT and non-HE PPDUs suitable for this purpose.

Operation according to examples above, and otherwise described in the present disclosure, enables transmitting and receiving multiple response frames when a N-link AP MLD does not include information regarding all the APs requested by a N-link STA MLD in an initial response frame (such as when the size of a N-link ML-probe response frame or a N-link ML-(re)association response frame including information regarding all the APs would exceed one or more frame size constraints). According to some aspects, a number of allowed association links (such as may establish a maximum number of allowed association links) parameter may be utilized managing the size of N-link requests, response frames, or both (such as to avoid situations in which the size of a response frame including information regarding all the APs requested by a non-AP MLD exceeds one or more frame size constraints, to reduce the number of response frames used to carry information regarding all the APs requested by a non-AP MLD, etc.). A number of allowed association links of some examples may be less than or equal to the number of APs affiliated with the AP MLD, less than or equal to the maximum number of simultaneous links for the AP MLD, or less than or equal to both of the foregoing. According to some examples, a number of allowed association links is less than the maximum number of simultaneous links for the AP MLD.

In operation according to some examples, a N-link AP MLD (such as any of the N-link AP MLDs 600, 700, 800, 900, and 1000) may transmit (such as via one or more of the 2G, 5GH, 5GL, 6GH, 6GL, and N^{th} band links), and a N-link STA MLD (such as any of the N-link AP STA MLDs 630, 730, 830, 930, and 1030) may receive (such as via one or more of the 2G, 5GH, 5GL., 6GH, 6GL, and N^{th} band links), an indication of a number of allowed association links with respect to the N-link AP MLD. For example, N-link MLO logic executed by the N-link AP MLD may operate to control one or more transmitters of the N-link AP MLD to transmit a number of allowed association links parameter. N-link MLO logic executed by the N-link ST MLD may operate to control one or more receivers of the N-link STA MLD to receive the number of allowed association links parameter. A number of allowed association links parameter may, for example, be carried in the common information field of a basic multi-link information element. According to some aspects, a number of allowed association links parameter may be transmitted by an AP MLD in addition to other signaling by the AP MLD with respect to MLO (such as signaling in the beacon, ML-probe response frame, ML-(re)association response frame, etc. that advertises the number of APs affiliated with the AP MLD, the maximum number of simultaneous links subfield of the basic multi-link element, etc.).

In N-link MLO according to some examples, the N-link STA MLD may transmit, and the N-link AP MLD may receive, a N-link request (such as a N-link ML-probe request of any of the examples of FIGS. 6, 7, and 8 or a N-link ML-(re)association request of the example of FIG. 9) requesting information regarding a number of APs based on or otherwise associated with the number of allowed association links with respect to the N-link AP MLD. According to some examples, a number of APs of the multiple APs an initial N-link request transmitted by a N-link STA MLD is regarding is less than or equal to the number of allowed association links. In some examples in which the number of allowed association links is less than less than the number of APs affiliated with the AP MLD, or otherwise less in number (H) than the value of N (H<N), a N-link STA MLD may solicit all N links in a request (such as a ML-probe request or ML-(re)association request), rather than the H links of the number of allowed association links. A N-link STA MLD, a N-link AP MLD, or both of this example may create a ranking for the N links and choose the best H links out of the N links.

In response to the N-link request, the N-link AP MLD may transmit, and the N-link STA MLD may receive, a response frame including information regarding a first set of APs of the plurality of APs that is less than or equal to the number of allowed association links. According to some aspects, N-link MLO logic executed by a N-link AP MLD may select a number of APs of the APs that are requested for including information in a response frame based at least in part on the number of allowed association links parameter. A response frame provided by the N-link AP MLD in response to the N-link request may include information regarding all APs that are requested in situations where the number of allowed association links is sufficiently small so as to enable the response frame to meet applicable size constraints. In situations where including information regarding all APs that are requested in the response frame would nevertheless exceed one or more frame size constraints, the number of subsequent response frames used to provide information with respect to APs missing from an initial response frame may be reduced.

In a situation where the response frame does not include information for all APs of the multiple APs requested by the N-link STA MLD, one or more subsequent response frames may be transmitted (such as in accordance with the examples of any of FIGS. 6, 7, 8, and 9, with or without a subsequent request regarding information for one or more APs of the APs missing in a previous response) for different sets of APs of the APs that are requested. Additionally or alternatively, in a situation where the response frame does not include information for one or more particular APs of the multiple APs requested by the N-link STA MLD, one or more subsequent requests may be transmitted (such as in accordance with the examples of either of FIG. 6 or 7) for information regarding the one or more particular APs. In either of the above situations, multiple response frames may be transmitted for different sets of APs of the APs that are requested.

As shown above in the example of FIG. 4, the impact on response frame size may be increased by N-link MLO implementations having multiple basic service sets, such as in 6G MLO. The impact of MBSSID on the size of a response frame may be avoided or mitigated according to some examples by omitting or otherwise not including some or all MBSSID elements in a response frame. For example, MBSSID elements may not be included in a N-link ML-probe response frame if a N-link ML-probe request is received requesting information for the N-link AP MLD pertaining to the AP transmitting the N-link ML-probe response frame . . . . In this example, the MBSSID elements may be omitted without loss of functionality because MBSSID elements for non-transmitting AP discovery may already be done through beacon and probe response frames. In an example where a N-link ML-probe request is received requesting information for a N-link AP MLD pertaining to a non-transmitting AP, MBSSID elements with the non-transmitting profile of only one AP which is the non-transmitting AP that is member of the target N-link AP MLD may be included in the response frame. That is, in this example, MBSSID elements for APs except for one or more MBSSID elements for an AP affiliated with the N-link AP MLD other than the AP of the wireless communication device transmitting the response frame may be omitted from the response frame.

In operation according to some examples, N-link MLO logic executed by a N-link AP MLD (such as any of the N-link AP MLDs 600, 700, 800, 900, and 1000) may cause the N-link AP MLD to omit MBSSID information from a response frame based at least in part on or otherwise associated with the N-link request requesting information regarding various APs (such as requesting information regarding an AP transmitting the response being affiliated with the N-link AP MLD, requesting information regarding an AP not transmitting the response being affiliated with the N-link AP MLD, etc.). According to an example, the N-link AP MLD may omit MBSSID elements for a set of APs when the APs affiliated with the N-link AP MLD associated with the N-link request include an AP transmitting the response frame which is associated with a transmitted BSSID in a MBSSID of the omitted MBSSID elements. According to another example, the N-link AP MLD may omit MBSSID elements for a set of APs except for one or more MBSSID elements for an AP associated with a BSSID in a MBSSID and affiliated with the N-link AP MLD other than the AP transmitting the response frame, when the APs affiliated with the N-link AP MLD do not include an AP transmitting the response frame.

Response frame size may be impacted by out of band (OOB) advertising (such as 6GH OOB advertising) in the response frame. That is, response frame size may be increased by N-link MLO implementations having OOB information with respect to frequency bands outside of a frequency band through which the response frame is transmitted and received included in the response frame. According to some examples, a response frame (such as a N-link ML-probe response frame) may be unburdened (such as through modification of 802.11 standards) from OOB advertising. Omitting OOB information from a N-link ML-probe response frame with respect to frequency bands outside of a frequency band through which the response frame is transmitted and received may be implemented without loss of functionality according to aspects. For example, 6 GHz OOB discovery may be sufficiently provided for in signaling implemented for functionality outside of the N-link request and response sessions of examples herein.

In operation according to some examples, N-link MIO logic executed by a N-link AP MLD (such as any of the N-link AP MLDs 600, 700, 800, 900, and 1000) may cause the N-link AP MLD to omit OOB information with respect to frequency bands outside of a frequency band through which one or more response frames are transmitted by the N-link AP MLD and received by a N-link STA MLD (such as any of the N-link STA MLDs 630, 730, 830, 930, and 1030). According to an example, the N-link AP MLD may omit OOB information from the N-link ML-probe response frames of a N-link ML-probe session.

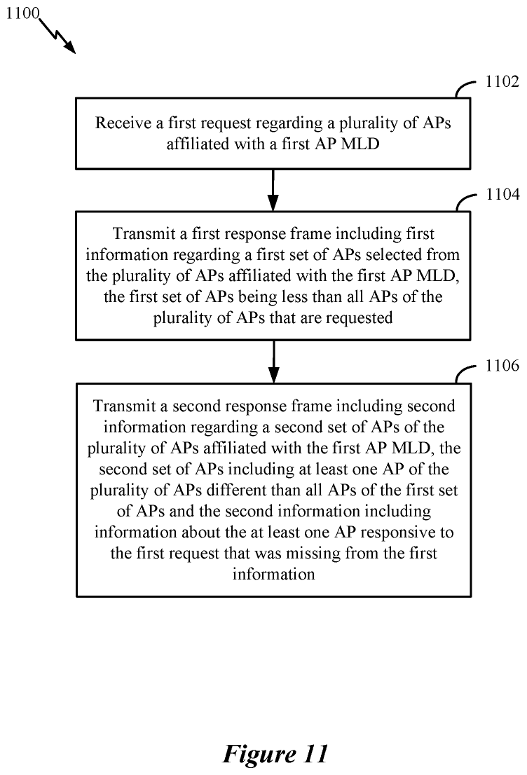

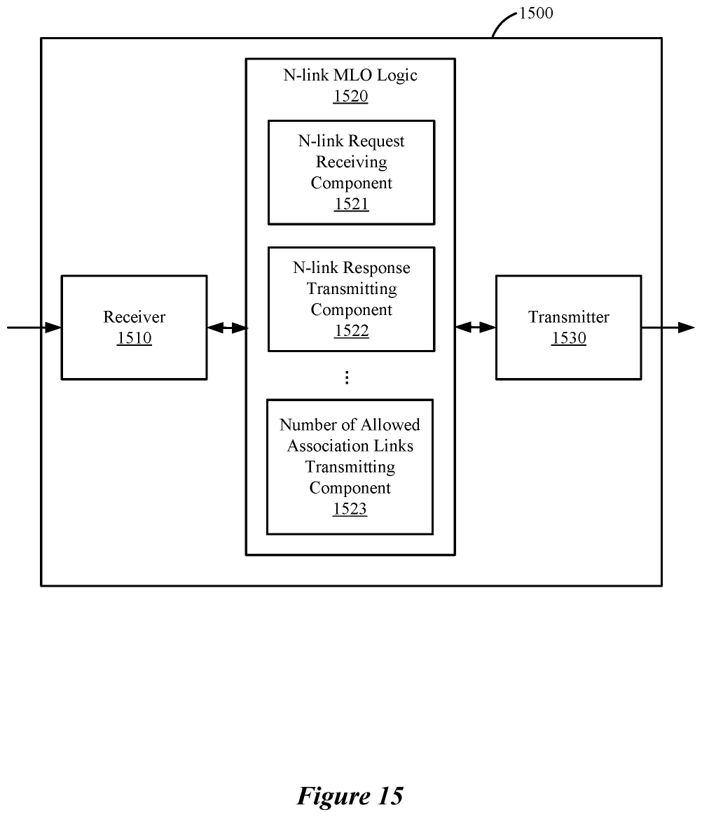

FIG. 11 shows a flowchart illustrating an example process 1100 performable at a wireless AP that supports transmitting multiple response frames of a N-link request and response session according to some aspects of the present disclosure. The operations of the process 1100 may be implemented by a wireless AP or its components as described herein. For example, the process 1100 may be performed by a wireless communication device, such as the wireless communication device 1500 described with reference to FIG. 15, operating as or within a wireless AP. In some examples, the process 1100 may be performed by a wireless AP such as one of the APs 102 described with reference to FIG. 1, one of the N-link AP MLDs 600, 700, 800, 900, and 1000 described with reference to FIGS. 6, 7, 8, 9, and 10, etc. The operations of process 1100 may, for example, be part of N-link MLO logic executed by the wireless AP for transmitting multiple response frames of a N-link request and response session in accordance with concepts herein.

In some examples, in block 1102, the wireless AP receives a first request regarding a plurality of APs affiliated with a first AP MLD. The wireless AP may, for example, be a N-link AP MLD and the first request may be a N-link ML-probe request or a N-link ML-(re)association request with respect to information (such as profile information) for multiple APs of the AP MLD.

In block 1104, according to some examples, the wireless AP transmits a first response frame including first information regarding a first set of APs selected from the plurality of APs affiliated with the first AP MLD, the first set of APs being less than all APs of the plurality of APs that are requested. Continuing with the example in which the wireless AP is a N-link AP MLD, the N-link AP MLD may operate to determine that the number of requested AP's indicated in the first request is greater than a constraint imposed with respect to the response frame. In accordance with some aspects, the N-link AP MLD may determine or otherwise identify the first set of APs of the APs requested for providing information regarding (such as per a per frame-capacity constraint). The first set of AP for which information is included in the first response frame may thus be less than all of the APs indicated by the request.

In some examples, in block 1106, the wireless AP transmits a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information. Continuing with the example in which the wireless AP is a N-link AP MLD, the N-link AP MLD may be operable to provide one or more follow-up, subsequent, or second response frames for providing information with respect to one or more APs of the APs that were requested in an initial or first ML-probe request. For example, the N-link AP MLD may be operable to determine or otherwise identify the second set of APs (such as one or more APs missing from the initial response frame) for providing information, as per the per frame-capacity constraint. The wireless AP may, for example, analyze a subsequent request (such as associated with a same N-link request and response session as the initial request) to determine or otherwise identify the second set of APs. In some examples, the wireless AP may transmit the second response frame without receiving a subsequent or second request. The wireless AP may, for example, store information regarding a subset of affiliated APs whose information has been included in previous response frame(s) and may analyze this information to determine or otherwise identify the second set of APs for providing information, as per the per frame-capacity constraint.

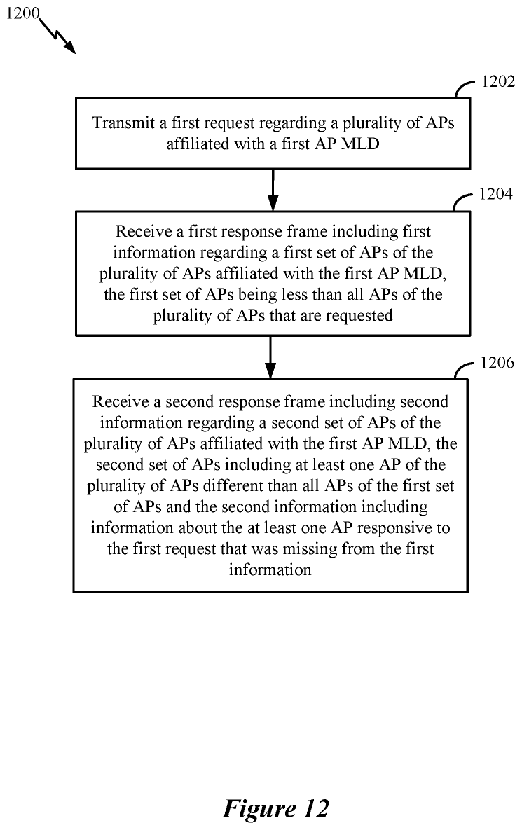

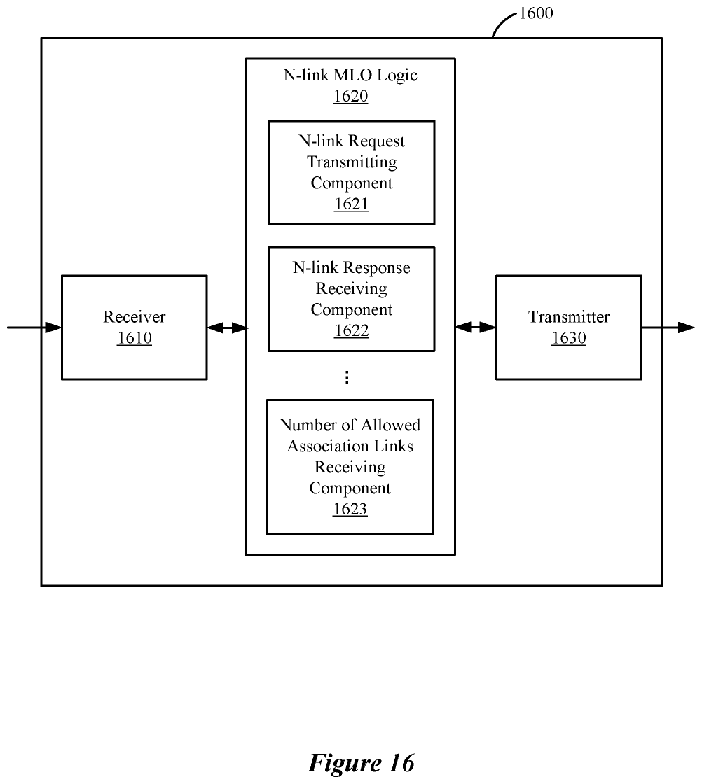

FIG. 12 shows a flowchart illustrating an example process 1200 performable at a wireless STA MLD that supports receiving multiple response frames of a N-link request and response session according to some aspects of the present disclosure. The operations of the process 1200 may be implemented by a wireless STA MLD or its components as described herein. For example, the process 1200 may be performed by a wireless communication device, such as the wireless communication device 1600 described with reference to FIG. 16, operating as or within a wireless STA MLD. In some examples, the process 1200 may be performed by a wireless STA MLD such as one of the STAs 104 described with reference to FIG. 1, one of the N-link STA MLDs 630, 730, 830, 930, and 1030 described with reference to FIGS. 6, 7, 8, 9, and 10, etc. The operations of process 1200 may, for example, be part of N-link MLO logic executed by the wireless STA MLD for receiving of multiple response frames of a N-link request and response session in accordance with concepts herein.

In some examples, in block 1202, the wireless STA MLD transmits a first request regarding a plurality of APs affiliated with a first AP multi-link device MLD. The first request may be a N-link ML-probe request or a N-link ML-(re)association request with respect to information (such as profile information) for multiple APs of an AP MLD. The first request may indicate a request for information regarding all the APs of the AP MLD. In some examples, the first request may include one or more fields that identifies each AP for which the information is requested (such as may indicate each affiliated AP of the AP MLD or some subset of APs).

In block 1204, according to some examples, the wireless STA MLD receives a first response frame including first information regarding a first set of APs of the plurality of APs affiliated with the first AP MLD, the first set of APs being less than all APs of the plurality of APs that are requested. The number of requested APs indicated in the first request may be greater than a constraint imposed with respect to the response frame. The first set of AP for which information is included in the first response frame may thus be less than all of the APs indicated by the request.

In some examples, in block 1206, the wireless STA MLD receive a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information. The second response frame may, for example, be a response frame of one or more follow-up or subsequent response frames for providing information with respect to one or more APs of the APs that were requested in an initial or first ML-probe request. In accordance with some examples, the wireless STA MLD may initiate one or more follow-up or subsequent response frames (such as the second response frame) for obtaining information with respect to one or more APs of the APs that were requested in an initial request. For example, the wireless STA MLD may transmit a follow-up, subsequent, or second request for the rest of the information with respect to the APs, or some portion thereof. According to some examples, the second response frame may be received in association with the first request without transmission of a second request.

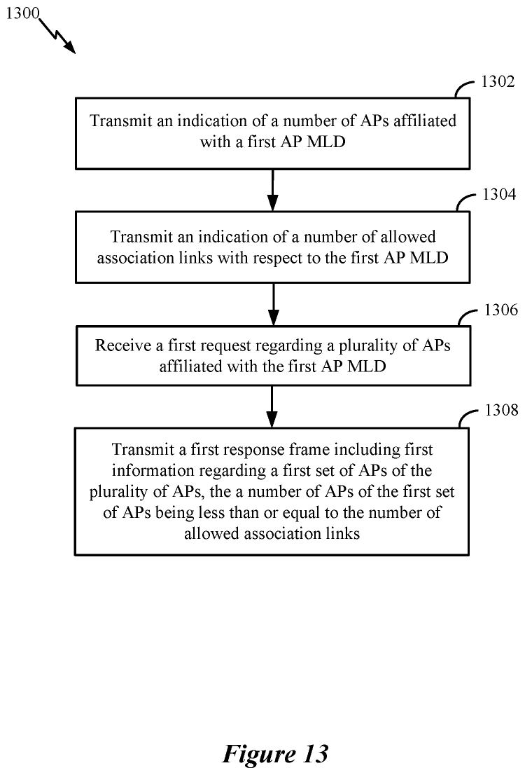

FIG. 13 shows a flowchart illustrating an example process 1300 performable at a wireless AP that supports transmitting response frames in accordance with a number of allowed association links parameter according to some aspects of the present disclosure. The operations of the process 1300 may be implemented by a wireless AP or its components as described herein. For example, the process 1300 may be performed by a wireless communication device, such as the wireless communication device 1500 described with reference to FIG. 15, operating as or within a wireless AP. In some examples, the process 1300 may be performed by a wireless AP such as one of the APs 102 described with reference to FIG. 1, one of the N-link AP MLDs 600, 700, 800, 900, and 1000 described with reference to FIGS. 6, 7, 8, 9, and 10, etc. The operations of process 1100 may, for example, be part of N-link MLO logic executed by the wireless AP for transmitting response frames in accordance with a number of allowed association links parameter according to concepts herein.

In some examples, in block 1302, the wireless AP transmits an indication of a number of APs affiliated with a first AP MLD. The wireless AP may, for example, be a N-link AP MLD and the indication of a number of APs affiliated with the first AP MLD may be transmitted as information of a maximum number of simultaneous links subfield included in one or more beacons associated with the first AP MLD.

In block 1304, according to some examples, the wireless AP transmits an indication of a number of allowed association links with respect to the first AP MLD. Continuing with the example in which the wireless AP is a N-link AP MLD, the number of allowed association links indication may, for example, be transmitted in the common information field of a basic multi-link information element. The indication of a number of association links may be a parameter for establishing a maximum number of allowed association links, such as may be utilized managing the size of N-link requests, N-link response frames, or both.

In some examples, in block 1306, the wireless AP receives a first request regarding a plurality of APs affiliated with the first AP MLD. Continuing still with the example of the wireless AP being a N-link AP MLD, the first request may be a N-link ML-probe request or a N-link ML-(re)association request with respect to information (such as profile information) for multiple APs of the AP MLD. The first request may, for example, request information regarding a number of APs based on or otherwise associated with the number of allowed association links with respect to the N-link AP MLD. According to some examples, a number of APs of the multiple APs the first request is regarding is less than or equal to the number of allowed association links. In some examples in which the number of allowed association links is less than less than the number of APs affiliated with the AP MLD, a N-link STA MLD may solicit information regarding a number of APs greater than the number of allowed association links all N links in a request. A N-link STA MLD, a N-link AP MLD, or both of this example may create a ranking for the N links and choose the best H links out of the N links.

In block 1308, according to some examples, the wireless AP transmits a first response frame including first information regarding a first set of APs of the plurality of APs, a number of APs of the first set of APs being less than or equal to the number of allowed association links. Continuing with the example in which the wireless AP is a N-link AP MLD, the first response frame may include information regarding all APs that are requested in situations where the number of allowed association links is sufficiently small so as to enable the response frame to meet applicable size constraints. However, in situations where including information regarding all APs that are requested in the response frame would nevertheless exceed one or more frame size constraints, whether the APs for which information is requested are less than or equal to the number of allowed association links or are in excess of the number of allowed association links, the N-link AP MLD may operate to determine that the number of requested APs indicated in the first request is greater than a constraint imposed with respect to the response frame. In accordance with some aspects, the N-link AP MLD may determine or otherwise identify the first set of APs of the APs requested for providing information regarding (such as per a per frame-capacity constraint). The first set of AP for which information is included in the first response frame may thus be less than all of the APs indicated by the request.

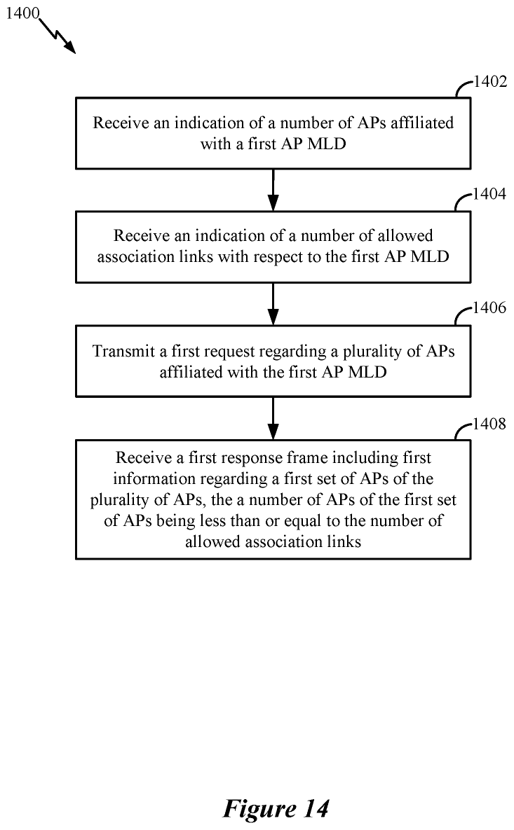

FIG. 14 shows a flowchart illustrating an example process 1400 performable at a wireless STA MLD that supports receiving response frames in accordance with a number of allowed association links parameter according to some aspects of the present disclosure. The operations of the process 1400 may be implemented by a wireless STA MLD or its components as described herein. For example, the process 1400 may be performed by a wireless communication device, such as the wireless communication device 1600 described with reference to FIG. 16, operating as or within a wireless STA MLD. In some examples, the process 1400 may be performed by a wireless STA MLD such as one of the STAs 104 described with reference to FIG. 1, one of the N-link STA MLDs 630, 730, 830, 930, and 1030 described with reference to FIGS. 6, 7, 8, 9, and 10, etc. The operations of process 1200 may, for example, be part of N-link MLO logic executed by the wireless STA MLD for receiving response frames transmitted in accordance with a number of allowed association links parameter according to concepts herein.

In some examples, in block 1402, the wireless STA MLD receives an indication of a number of APs affiliated with a first AP MLD. The indication of a number of APs affiliated with the first AP MLD may be transmitted as information of a maximum number of simultaneous links subfield included in one or more beacons associated with the first AP MLD.

In block 1404, according to some examples, the wireless STA MLD receives an indication of a number of allowed association links with respect to the first AP MLD. The number of allowed association links indication may, for example, be transmitted in the common information field of a basic multi-link information element. The indication of a number of association links may be a parameter for establishing a maximum number of allowed association links, such as may be utilized managing the size of N-link requests, response frames, or both.

In some examples, in block 1406, the wireless STA MLD transmits a first request regarding a plurality of APs affiliated with the first AP MLD. The first request may be a N-link ML-probe request or a N-link ML-(re)association request with respect to information (such as profile information) for multiple APs of the AP MLD. The first request may, for example, request information regarding a number of APs based on or otherwise associated with the number of allowed association links with respect to the N-link AP MLD. According to some examples, a number of APs of the multiple APs the first request is regarding is less than or equal to the number of allowed association links.

In block 1408, according to some examples, the wireless STA MLD receives a first response frame including first information regarding a first set of APs of the plurality of APs, a number of APs of the first set of APs being less than or equal to the number of allowed association links. The first response frame may include information regarding all APs that are requested in situations where the number of allowed association links is sufficiently small so as to enable the response frame to meet applicable size constraints. However, in situations where including information regarding all APs that are requested in the response frame would nevertheless exceed one or more frame size constraints, whether the APs for which information is requested are less than or equal to the number of allowed association links or are in excess of the number of allowed association links, the first response frame may include information for the first set of AP which is less than all of the APs indicated by the request.

FIG. 15 shows a block diagram of an example wireless communication device 1500 that supports multiple response frames of a N-link request and response session according to some aspects of the present disclosure, as well as that supports transmitting response frames in accordance with a number of allowed association links parameter according to some aspects of the present disclosure. In some examples, the wireless communication device 1500 is configured or operable to perform the process 1100 described with reference to FIG. 11. The wireless communication device 1500, in some examples, is configured or operable to perform the process 1300 described with reference to FIG. 13. One or more of the components shown with respect to the example of the wireless communication device 1500 of FIG. 15 may be omitted in some implementations. Accordingly, some examples of the wireless communication device 1500 may be configured to support one or the other of transmitting multiple response frames of a N-link request and response session or transmitting response frames in accordance with a number of allowed association links parameter. In various examples, the wireless communication device 1500 may be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1500 may be a device for use in an AP, such as AP 102 described with reference to FIG. 1. In some other examples, the wireless communication device 1500 may be an AP that includes such a chip, SoC, chipset, package or device as well as multiple antennas. The wireless communication device 1500 is capable of transmitting and receiving wireless communications in the form of, for example, wireless packets. For example, the wireless communication device may be configured or operable to transmit and receive packets in the form of physical layer PPDUs and MPDUs conforming to one or more of the IEEE 802.11 family of wireless communication protocol standards. In some examples, the wireless communication device 1500 also includes or may be coupled with an application processor which may be further coupled with another memory. In some examples, the wireless communication device 1500 further includes at least one external network interface that enables communication with a core network or backhaul network to gain access to external networks including the Internet.

The wireless communication device 1500 of the example in FIG. 15 is shown as including a receiver 1510, N-link MLO logic 1520, and a transmitter 1530. The N-link MLO logic 1520 of the example (such as may be part of a communications manager implemented by the wireless communication device 1500) is shown as including a N-link request receiving component 1521, a N-link response transmitting component 1522, and a number of allowed association links transmitting component 1523. Portions of the N-link MLO logic 1520, or one or more of the components 1521, 1522, and 1523 thereof, may be implemented at least in part in hardware or firmware. For example, the N-link request receiving component 1521 and the N-link response transmitting component 1522 may be implemented at least in part by a modem. In some examples, at least some portion of the N-link MLO logic 1520, and of the components 1521, 1521, and 1523, are implemented at least in part by a processor and as software stored in a memory. For example, portions of the N-link MLO logic 1520, or one or more of the components 1521, 1522, or 1523, may be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 1500). For example, a processing system of the device 1500 may refer to a system including the various other components or subcomponents of the device 1500, such as the processor, or the receiver 1510 and the transmitter 1530 (collectively a transceiver), or a communications manager, or other components or combinations of components of the device 1500. The processing system of the device 1500 may interface with other components of the device 1500, and may process information received from other components (such as inputs or signals) or output information to other components. For example, a chip or modem of the device 1500 may include a processing system, a first interface to output information and a second interface to obtain information. In some implementations, the first interface may refer to an interface between the processing system of the chip or modem and a transmitter, such that the device 1500 may transmit information output from the chip or modem. In some implementations, the second interface may refer to an interface between the processing system of the chip or modem and a receiver, such that the device 1500 may obtain information or signal inputs, and the information may be passed to the processing system. A person having ordinary skill in the art will readily recognize that the first interface also may obtain information or signal inputs, and the second interface also may output information or signal outputs.

The N-link MLO logic 1520 of some examples provides means for transmitting multiple response frames of a N-link request and response session according to some examples. The N-link request receiving component 1521 and the N-link response transmitting component 1522 of the N-link MLO logic 1520, as may be implemented at least in part by one or more processors of a modem, the receiver 1510, the transmitter 1530, or other components or combinations of components of the device 1500, may operate cooperatively to perform various functions as described above with reference to FIGS. 6, 7, 8, 9, and 10.

The N-link request receiving component 1521 is capable of, configured to, or operable to receive N-link requests (such as N-link ML-probe requests, N-link ML-(re)association requests, etc.) for information regarding APs of an AP MLD. According to some examples, the N-link MLO request receiving component 1521 may determine that a number of requested APs indicated in the N-link request is greater than one or more constraints imposed with respect to the response frame will accommodate information for. In a situation in which a N-link request and response session includes an initial N-link request and one or more subsequent requests, the N-link request receiving component 1521 may operate to control receiving each N-link request of the N-link request and response session.

The N-link response transmitting component 1522 is capable of, configured to, or operable to transmit one or more response frames (such as N-link ML-probe response frames, N-link ML-(re)association response frames, etc.) in association with a received N-link request. For example, the N-link response transmitting component 1522 of some examples may control transmission of an initial response frame and one or more subsequent response frames of a N-link request and response session, with or without the N-link request receiving component 1521 having received a subsequent request. According to some examples, the N-link response transmitting component 1522 may operate to determine or otherwise identify a first set of APs of the APs requested for providing information in an initial response frame, as per one or more per frame-capacity constraints. The N-link response transmitting component 1522 may additionally operate to determine or otherwise identify a second set of APs missing from the initial response frame for providing information in one or more subsequent response frames, as per the one or more per frame-capacity constraints.

The number of allowed association links transmitting component 1523 is capable of, configured to, or operable to transmit a number of allowed association links parameter configured for managing the size of N-link requests, response frames, or both. According to some examples, the number of allowed association links transmitting component 1523 operates cooperatively with the N-link request receiving component 1521 to determine that a number of APs of a received N-link request is greater than a number of allowed association links. Additionally or alternatively, the number of allowed association links transmitting component 1523 operates cooperatively with the N-link response transmitting component 1522 to determine or otherwise identify one or more sets of APs of the APs requested for providing information in one or more response frames.

FIG. 16 shows a block diagram of an example wireless communication device 1600 that supports receiving multiple response frames of a N-link request and response session according to some aspects of the present disclosure, as well as that supports receiving response frames transmitted in accordance with a number of allowed association links parameter according to some aspects of the present disclosure. In some examples, the wireless communication device 1600 is configured or operable to perform the process 1200 described with reference to FIG. 12. The wireless communication device 1600, in some examples, is configured or operable to perform the process 1400 described with reference to FIG. 14. One or more of the components shown with respect to the example of the wireless communication device 1600 of FIG. 16 may be omitted in some implementations. Accordingly, some examples of the wireless communication device 1600 may be configured to support one or the other of receiving multiple response frames of a N-link request and response session or receiving response frames transmitted in accordance with a number of allowed association links parameter. In various examples, the wireless communication device 1600 may be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”).

In some examples, the wireless communication device 1600 may be a device for use in a STA MLD, such as STA 104 described with reference to FIG. 1. In some other examples, the wireless communication device 1600 may be a STA MLD that includes such a chip, SoC, chipset, package or device as well as multiple antennas. The wireless communication device 1600 is capable of transmitting and receiving wireless communications in the form of, for example, wireless packets. For example, the wireless communication device may be configured or operable to transmit and receive packets in the form of physical layer PPDUs and MPDUs conforming to one or more of the IEEE 802.11 family of wireless communication protocol standards. In some examples, the wireless communication device 1600 also includes or may be coupled with an application processor which may be further coupled with another memory. In some examples, the wireless communication device 1600 further includes a user interface (UI) (such as a touchscreen or keypad) and a display, which may be integrated with the UI to form a touchscreen display. In some examples, the wireless communication device 1600 may further include one or more sensors such as, for example, one or more inertial sensors, accelerometers, temperature sensors, pressure sensors, or altitude sensors.

The wireless communication device 1600 of the example of FIG. 16 is shown as including a receiver 1610, N-link MLO logic 1620, and a transmitter 1630. The N-link MLO logic 1620 of the example (such as may be part of a communications manager implemented by the wireless communication device 1600) is shown as including a N-link request transmitting component 1621, a N-Link response receiving component 1622, and a number of allowed association links receiving component 1623. Portions of the N-link MLO logic 1620, or one or more of the components 1621, 1622, and 1623 thereof, may be implemented at least in part in hardware or firmware. For example, the N-link request transmitting component 1621 and the N-link response receiving component 1622 may be implemented at least in part by a modem. In some examples, at least some of the components 1621, 1622, and 1623 are implemented at least in part by a processor and as software stored in a memory. For example, portions of the N-link MLO logic 1620, or one or more of the components 1621, 1622, or 1623, may be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 1600). For example, a processing system of the device 1600 may refer to a system including the various other components or subcomponents of the device 1600, such as the processor, or the receiver 1610 and the transmitter 1630 (collectively a transceiver), or other components or combinations of components of the device 1600. The processing system of the device 1600 may interface with other components of the device 1600, and may process information received from other components (such as inputs or signals) or output information to other components. For example, a chip or modem of the device 1600 may include a processing system, a first interface to output information and a second interface to obtain information. In some implementations, the first interface may refer to an interface between the processing system of the chip or modem and a transmitter, such that the device 1600 may transmit information output from the chip or modem. In some implementations, the second interface may refer to an interface between the processing system of the chip or modem and a receiver, such that the device 1600 may obtain information or signal inputs, and the information may be passed to the processing system. A person having ordinary skill in the art will readily recognize that the first interface also may obtain information or signal inputs, and the second interface also may output information or signal outputs.

The N-link MIO logic 1620 of some examples provides means for receiving multiple response frames of a N-link request and response session according to some examples. The N-link request transmitting component 1621 and the N-link response receiving component 1622 of the N-link MLO logic 1620, as may be implemented at least in part by one or more processors of a modem, the receiver 1610, the transmitter 1630, or other components or combinations of components of the device 1600, may operate cooperatively to perform various functions as described above with reference to FIGS. 6, 7, 8, 9, and 10.

The N-link request receiving component 1621 is capable of, configured to, or operable to transmit N-link requests (such as N-link ML-probe requests, N-link ML-(re)association requests, etc.) for information regarding APs of an AP MLD. In a situation in which a N-link request and response session includes an initial N-link request and one or more subsequent requests, the N-link request transmitting component 1621 may operate to control transmission of one or more subsequent requests for obtaining the remaining information missing from one or more response frames. According to some examples, the N-link request transmitting component 1621 may operate cooperatively with the N-link response receiving component 1622 to await one or more follow-up or subsequent response frames.

The N-link response receiving component 1622 is capable of, configured to, or operable to receive one or more response frames (such as N-link ML-probe response frames, N-link ML-(re)association response frames, etc.) in association with a transmitted N-link request. For example, the N-link response receiving component 1622 of some examples may control receiving of an initial response frame and one or more subsequent response frames of a N-link request and response session, with or without the N-link request transmitting component 1621 having transmitted a subsequent request. According to some examples, the N-link response receiving component 1622 may operate to determine or otherwise identify a set of APs of the APs requested for information is provided in an initial response frame is less than all the APs indicated by a N-link request. The N-link response receiving component 1622 may operate cooperatively with the N-link request transmitting component 1621 to control transmission of one or more N-link requests regarding APs missing from a response frame for obtaining information in one or more subsequent response frames.

The number of allowed association links receiving component 1623 is capable of, configured to, or operable to receiving a number of allowed association links parameter configured for managing the size of N-link requests, response frames, or both. According to some examples, the number of allowed association links receiving component 1623 operates cooperatively with the N-link request transmitting component 1621 to request information in a N-link request regarding a number of APs which is less than or equal to a number of allowed association links.

Implementation examples are described in the following numbered aspects:

Aspect 1. Methods, apparatuses, and articles for wireless communication may provide for transmitting a first request regarding a plurality of APs affiliated with a first AP MLD, receiving a first response frame including first information regarding a first set of APs of the plurality of APs affiliated with the first AP MLD, the first set of APs being less than all APs of the plurality of APs that are requested, and receiving a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

Aspect 2. The methods, apparatuses, and articles of aspect 1, may provide for, responsive to the first information missing information of one or more APs of the plurality of APs that are requested, transmitting a second request for additional information missing from the first information about APs of the plurality of APs that are requested.

Aspect 3. The methods, apparatuses, and articles of aspect 2, wherein the first information included in the first response frame includes one or more indicators for indicating that the first information is missing information of the one or more APs of the plurality of APs that are requested and the second request is transmitted in association with the one or more indicators indicating that the first information is missing information of the one or more APs.

Aspect 4. The methods, apparatuses, and articles of any of aspects 2 or 3, may provide for selecting, in association with the first information missing information of the one or more APs of the plurality of APs that are requested, the at least one AP as having information missing in the first information received in response to the first request, the second request including an indication of the at least one AP.

Aspect 5. The methods, apparatuses, and articles of any of aspects 2, 3, or 4, wherein at least one of the first request or the second request includes an indication of APs of the plurality of APs that are requested.

Aspect 6. The methods, apparatuses, and articles of aspect 1, may provide for receiving the first response frame and the second response frame in association with the first request without transmission of a second request regarding the at least one AP.

Aspect 7. The methods, apparatuses, and articles of any of aspects 1, 2, 3, 4, 5, or 6, may provide for selecting a wireless link as having one or more attributes facilitating transmission of response frames to include information regarding multiple APs affiliated with the first AP MLD, the first request being transmitted via the wireless link.

Aspect 8. The methods, apparatuses, and articles of aspect 7, wherein the one or more attributes comprise at least one of a MCS rate, a bandwidth, or a number of spatial streams.

Aspect 9. The methods, apparatuses, and articles of any of aspects 1, 2, 3, 4, 5, 6, 7, or 8, may provide receiving an indication of a number of allowed association links with respect to the first AP MLD, a number of APs of the plurality of APs the first request is regarding being less than or equal to the number of allowed association links.

Aspect 10. The methods, apparatuses, and articles of any of aspects 1, 2, 3, 4, 5, 6, 7, 8, or 9, wherein the first request comprises a first request for association or reassociation with multiple APs affiliated with the first AP MLD, the first response frame comprises a first ML-association or ML-reassociation response frame, and the second response frame comprises a second ML-association or ML-reassociation response frame.

Aspect 11. The methods, apparatuses, and articles of any of aspects 1, 2, 3, 4, 5, 6, 7, 8, or 9 wherein the first request comprises a first ML-probe request for information regarding the plurality of APs affiliated with the first AP MLD, the first response frame comprises a first ML-probe response frame, and the second response frame comprises a second ML-probe response frame.

Aspect 12. The methods, apparatuses, and articles of aspect 11, wherein a first AP transmitting the first ML-probe response frame and the second ML-probe response frame is an AP other than the plurality of APs affiliated with the first AP MLD associated with the first request for information, the first AP associated with a transmitted BSSID in a MBSSID, the first ML-probe response frame including one or more MBSSID elements for a second AP, the second AP being an AP affiliated with the AP MLD other than the first AP transmitting the first ML-probe response frame.

Aspect 13. The methods, apparatuses, and articles of any of aspects 11 or 12, wherein OOB information with respect to frequency bands outside of a frequency band through which the first ML-probe response frame and the second ML-probe response frame are received is omitted from the first ML-probe response frame and the second ML-probe response frame.

Aspect 14. Methods, apparatuses, and articles for wireless communication may provide for receiving a first request regarding a plurality of APs affiliated with a first AP MLD, transmitting a first response frame including first information regarding a first set of APs selected from the plurality of APs affiliated with the first AP MLD, the first set of APs being less than all APs of the plurality of APs that are requested, and transmitting a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

Aspect 15. The methods, apparatuses, and articles of aspect 14, may provide for selecting APs of the first set of APs in association with the information for the plurality of APs that are requested exceeding a size of the first response frame.

Aspect 16. The methods, apparatuses, and articles of any of aspects 14 or 15, may provide for receiving, in association with the first information missing information of one or more APs of the plurality of APs that are requested, a second request regarding the at least one AP, wherein the second request includes an indication of the at least one AP, and selecting, in association with the second request, the second set of APs for transmission in the second response frame.

Aspect 17. The methods, apparatuses, and articles of aspect 16, may provide for including in the first response frame one or more indicators for indicating that the first information is missing information of the one or more APs of the plurality of APs that are requested, the second request being received in association with the one or more indicators indicating that the first information is missing information of the one or more APs.

Aspect 18. The methods, apparatuses, and articles of aspect 14, may provide for transmitting the first response frame and the second response frame in association with the first request without receiving a second request regarding the at least one AP.

Aspect 19. The methods, apparatuses, and articles of any of aspects 14, 15, 16, 17, or 18, may provide for transmitting the first response frame in one or more MMPDUs sized to accommodate AP MLD response frames including information regarding multiple APs.

Aspect 20. The methods, apparatuses, and articles of any of aspects 14, 15, 16, 17, 18, or 19, may provide for transmitting an indication of a number of allowed association links with respect to the first AP MLD, a number of APs of the plurality of APs selected for including information in the first response frame being less than or equal to the number of allowed association links.

Aspect 21. The methods, apparatuses, and articles of any of aspects 14, 15, 16, 17, 18, or 19, wherein the first request comprises a first ML probe request for information regarding the plurality of APs affiliated with the first AP MLD, the first response frame comprises a first ML-probe response frame, and the second response frame comprises a second ML-probe response frame, and may provide for omitting information from the first ML-probe response frame selected from the group consisting of MBSSID elements for the first set of APs when the plurality of APs affiliated with the first AP MLD associated with the first request for information include a first AP of the wireless communication device transmitting the first ML-probe response frame, the first AP associated with a transmitted BSSID in a MBSSID; MBSSID elements for the first set of APs except for one or more MBSSID elements for a second AP, the second AP being an AP affiliated with the first AP MLD other than the first AP of the wireless communication device transmitting the first ML-probe response frame, when the plurality of APs affiliated with the first AP MLD associated with the first request for information do not include an AP transmitting the first ML-probe response frame, the first AP associated with a BSSID in a MBSSID; and OOB information with respect to frequency bands outside of a frequency band through which the first ML-probe response frame and the second ML-probe response frame are receive.

Aspect 22. Methods, apparatuses, and articles for wireless communication may provide for receiving an indication of a number of APs affiliated with a first AP MLD, receiving an indication of a number of allowed association links with respect to the first AP MLD, transmitting a first request regarding a plurality of APs affiliated with the first AP MLD, and receiving a first response frame including first information regarding a first set of APs of the plurality of APs, a number of APs of the first set of APs being less than or equal to the number of allowed association links.

Aspect 23. The methods, apparatuses, and articles of aspect 22, wherein a number of APs of the plurality of APs the first request is regarding is less than or equal to the number of allowed association links.

Aspect 24. The methods, apparatuses, and articles of any of aspects 22 or 23, wherein the number of APs of the first set of APs is less than the number of allowed association links, and may provide for analyzing the first information for carrying information of less than all APs of the plurality of APs that are requested, and transmitting, in association with the first information carrying information of less than all APs of the plurality of APs that are requested, a second request.

Aspect 25. The methods, apparatuses, and articles of any of aspects 22, 23, or 24, may provide for, responsive to the first information missing information of a first AP of the plurality of APs that are requested, transmitting a second request for additional information missing from the first information about APs of the plurality of APs that are requested, the second request including an indication of the first AP.

Aspect 26. Methods, apparatuses, and articles for wireless communication may provide for transmitting an indication of a number of APs affiliated with a first AP MLD, transmitting an indication of a number of allowed association links with respect to the first AP MLD, receiving a first request regarding a plurality of APs affiliated with the first AP MLD, and transmitting a first response frame including first information regarding a first set of APs of the plurality of APs, a number of APs of the first set of APs being less than or equal to the number of allowed association links.

Aspect 27. The methods, apparatuses, and articles of aspect 26, wherein a number of APs of the plurality of APs the first request is regarding is less than or equal to the number of allowed association links.

Aspect 28. The methods, apparatuses, and articles of any of aspects 26 or 27, wherein the number of APs of the first set of APs is less than the number of allowed association links, and may provide for receiving, in association with the first information carrying information of less than all APs of the plurality of APs that are requested, a second request.

Aspect 29. The methods, apparatuses, and articles of any of aspects 26, 27, or 28, may provide for, responsive to the first information missing information of a first AP of the plurality of APs that are requested, receiving a second request for additional information missing from the first information about APs of the plurality of APs that are requested, the second request including an indication of the first AP.

As used herein, the term “determine” or “determining” encompasses a wide variety of actions and, therefore, “determining” may include calculating, computing, processing, deriving, investigating, looking up (such as via looking up in a table, a database or another data structure), identifying, inferring, ascertaining, measuring, and the like. Also, “determining” may include receiving (such as receiving information and/or receiving an indication), accessing (such as accessing data stored in memory), transmitting (such as transmitting information) and the like. Also, “determining” may include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also may be implemented in combination in a single implementation. Conversely, various features that are described in the context of a single implementation also may be implemented in multiple examples separately or in any suitable subcombination. As such, although features may be described above as acting in particular combinations, and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted may be incorporated in the example processes that are schematically illustrated. For example, one or more additional operations may be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems may generally be integrated together in a single software product or packaged into multiple software products.

What is claimed is:

1. A wireless communication device, comprising:
at least one memory;
at least one processor communicatively coupled with the at least one memory, the at least one processor operable to cause the wireless communication device to:
transmit a first request regarding a plurality of access points (APs) affiliated with a first AP multi-link device (MLD);
receive a first response frame including first information regarding a first set of APs of the plurality of APs affiliated with the first AP MLD, the first set of APs being less than all APs of the plurality of APs that are requested; and
receive a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

2. The wireless communication device of claim 1, wherein the at least one processor is operable to cause the wireless communication device to:
responsive to the first information missing information of one or more APs of the plurality of APs that are requested, transmit a second request for additional information missing from the first information about APs of the plurality of APs that are requested.

3. The wireless communication device of claim 2, wherein the first information included in the first response frame includes one or more indicators for indicating that the first information is missing information of the one or more APs of the plurality of APs that are requested and the second request is transmitted in association with the one or more indicators indicating that the first information is missing information of the one or more APs.

4. The wireless communication device of claim 2, wherein the at least one processor is operable to cause the wireless communication device to:
select, in association with the first information missing information of the one or more APs of the plurality of APs that are requested, the at least one AP as having information missing in the first information received in response to the first request, the second request including an indication of the at least one AP.

5. The wireless communication device of claim 4, wherein at least one of the first request or the second request includes an indication of APs of the plurality of APs that are requested.

6. The wireless communication device of claim 1, wherein the first response frame and the second response frame are received in association with the first request without transmission of a second request regarding the at least one AP.

7. The wireless communication device of claim 1, wherein the at least one processor is operable to cause the wireless communication device to:
select a wireless link as having one or more attributes facilitating transmission of response frames to include information regarding multiple APs affiliated with the first AP MLD, the first request being transmitted via the wireless link.

8. The wireless communication device of claim 7, wherein the one or more attributes comprise at least one of a modulation and coding scheme (MCS) rate, a bandwidth, or a number of spatial streams.

9. The wireless communication device of claim 1, wherein the at least one processor is operable to cause the wireless communication device to:
receive an indication of a number of allowed association links with respect to the first AP MLD, a number of APs of the plurality of APs the first request is regarding being less than or equal to the number of allowed association links.

10. The wireless communication device of claim 1, wherein the first request comprises a first request for association or reassociation with multiple APs affiliated with the first AP MLD, the first response frame comprises a first multi-link (ML)-association or ML-reassociation response frame, and the second response frame comprises a second ML-association or ML-reassociation response frame.

11. The wireless communication device of claim 1, wherein the first request comprises a first multi-link (ML)-probe request for information regarding the plurality of APs affiliated with the first AP MLD, the first response frame comprises a first ML-probe response frame, and the second response frame comprises a second ML-probe response frame.

12. The wireless communication device of claim 11, wherein a first AP transmitting the first ML-probe response frame and the second ML-probe response frame is an AP other than the plurality of APs affiliated with the first AP MLD associated with the first request for information, the first AP associated with a transmitted basic service set identification (BSSID) in a multiple BSSID (MBSSID), the first ML-probe response frame including one or more MBSSID elements for a second AP, the second AP being an AP affiliated with the AP MLD other than the first AP transmitting the first ML-probe response frame.

13. The wireless communication device of claim 11, wherein out of band (OOB) information with respect to frequency bands outside of a frequency band through which the first ML-probe response frame and the second ML-probe response frame are received is omitted from the first ML-probe response frame and the second ML-probe response frame.

14. A wireless communication device, comprising:
at least one memory;
at least one processor communicatively coupled with the at least one memory, the at least one processor operable to cause the wireless communication device to:
receive a first request regarding a plurality of access points (APs) affiliated with a first AP multi-link device (MLD);
transmit a first response frame including first information regarding a first set of APs selected from the plurality of APs affiliated with the first AP MLD, the first set of APs being less than all APs of the plurality of APs that are requested; and
transmit a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

15. The wireless communication device of claim 14, wherein the at least one processor is operable to cause the wireless communication device to:
select APs of the first set of APs in association with the information for the plurality of APs that are requested exceeding a size of the first response frame.

16. The wireless communication device of claim 14, wherein the at least one processor is operable to cause the wireless communication device to:
receive, in association with the first information missing information of one or more APs of the plurality of APs that are requested, a second request regarding the at least one AP, wherein the second request includes an indication of the at least one AP; and
select, in association with the second request, the second set of APs for transmission in the second response frame.

17. The wireless communication device of claim 16, wherein the at least one processor is operable to cause the wireless communication device to:
include in the first response frame one or more indicators for indicating that the first information is missing information of the one or more APs of the plurality of APs that are requested, the second request being received in association with the one or more indicators indicating that the first information is missing information of the one or more APs.

18. The wireless communication device of claim 14, wherein the first response frame and the second response frame are transmitted in association with the first request without receiving a second request regarding the at least one AP.

19. The wireless communication device of claim 14, wherein the first response frame is transmitted in one or more media access control (MAC) management protocol data units (MMPDUs) sized to accommodate AP MLD response frames including information regarding multiple APs.

20. The wireless communication device of claim 14, wherein the at least one processor is operable to cause the wireless communication device to:
transmit an indication of a number of allowed association links with respect to the first AP MLD, a number of APs of the plurality of APs selected for including information in the first response frame being less than or equal to the number of allowed association links.

21. The wireless communication device of claim 14, wherein the first request comprises a first multi-link (ML) probe request for information regarding the plurality of APs affiliated with the first AP MLD, the first response frame comprises a first ML-probe response frame, and the second response frame comprises a second ML-probe response frame, and wherein the at least one processor is operable to cause the wireless communication device to:
omit information from the first ML-probe response frame selected from the group consisting of:
multiple basic service set identification (MBSSID) elements for the first set of APs when the plurality of APs affiliated with the first AP MLD associated with the first request for information include a first AP of the wireless communication device transmitting the first ML-probe response frame, the first AP associated with a transmitted basic service set identification (BSSID) in a MBSSID;
MBSSID elements for the first set of APs except for one or more MBSSID elements for a second AP, the second AP being an AP affiliated with the first AP MLD other than the first AP of the wireless communication device transmitting the first ML-probe response frame, when the plurality of APs affiliated with the first AP MLD associated with the first request for information do not include an AP transmitting the first ML-probe response frame, the first AP associated with a BSSID in a MBSSID; and
out of band (OOB) information with respect to frequency bands outside of a frequency band through which the first ML-probe response frame and the second ML-probe response frame are receive.

22. A wireless communication device, comprising:
at least one memory;
at least one processor communicatively coupled with the at least one memory, the at least one processor operable to cause the wireless communication device to:
receive an indication of a number of access points (APs) affiliated with a first AP multi-link device (MLD);
receive an indication of a number of allowed association links with respect to the first AP MLD;
transmit a first request regarding a plurality of APs affiliated with the first AP MLD; and
receive a first response frame including first information regarding a first set of APs of the plurality of APs, a number of APs of the first set of APs being less than or equal to the number of allowed association links.

23. The wireless communication device of claim 22, wherein a number of APs of the plurality of APs the first request is regarding is less than or equal to the number of allowed association links.

24. The wireless communication device of claim 22, wherein the number of APs of the first set of APs is less than the number of allowed association links, wherein the at least one processor is operable to cause the wireless communication device to:
analyze the first information for carrying information of less than all APs of the plurality of APs that are requested; and
transmit, in association with the first information carrying information of less than all APs of the plurality of APs that are requested, a second request.

25. The wireless communication device of claim 22, wherein the at least one processor is operable to cause the wireless communication device to:
responsive to the first information missing information of a first AP of the plurality of APs that are requested, transmit a second request for additional information missing from the first information about APs of the plurality of APs that are requested, the second request including an indication of the first AP.

26. A method for wireless communication performable at a wireless station, comprising:
transmitting a first request regarding a plurality of access points (APs) affiliated with a first AP multi-link device (MLD);
receiving a first response frame including first information regarding a first set of APs of the plurality of APs affiliated with the first AP MLD, the first set of APs being less than all APs of the plurality of APs that are requested; and
receiving a second response frame including second information regarding a second set of APs of the plurality of APs affiliated with the first AP MLD, the second set of APs including at least one AP of the plurality of APs different than all APs of the first set of APs and the second information including information about the at least one AP responsive to the first request that was missing from the first information.

27. The method of claim 26, further comprising:
responsive to the first information missing information of one or more APs of the plurality of APs that are requested, transmitting a second request for additional information missing from the first information about APs of the plurality of APs that are requested.

28. The method of claim 27, further comprising:
selecting, in association with the first information missing information of the one or more APs of the plurality of APs that are requested, the at least one AP as having information missing in the first information received in response to the first request, the second request including an indication of the at least one AP.

29. The method of claim 26, wherein the first response frame and the second response frame are received in association with the first request without transmission of a second request regarding the at least one AP.

30. The method of claim 26, further comprising:
receiving an indication of a number of allowed association links with respect to the first AP MLD, a number of APs of the plurality of APs the first request is regarding being less than or equal to the number of allowed association links.
